(19) United States
(12) Patent Application Publication
(10) Pub. No.: US 2005/0069812 A1
(43) Pub. Date: Mar. 31, 2005

(54) Planographic printing plate precursor

(75) Inventors: Kazuo Maemoto, Shizuoka-ken (JP); Ippei Nakamura, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/950,402

(22) Filed: Sep. 28, 2004

(30) Foreign Application Priority Data
Sep. 29, 2003 (JP) 2003-337085

(51) Int. Cl. G03C 1/494

(52) U.S. Cl. 430/270.1

(57) ABSTRACT

The present invention provides a planographic printing plate precursor including a support, and a recording layer which is formed on the support and includes a water-insoluble and alkali-soluble resin having active hydrogen in a main chain thereof and an infrared absorbent, the solubility of the recording layer in an aqueous alkaline solution being increased by exposure to light; and a planographic printing plate precursor including a support, and a recording layer formed on the support, wherein the recording layer includes a lower layer which is formed on the support and includes a water-insoluble and alkali-soluble resin having active hydrogen in a main chain thereof, and an upper layer which is formed on the lower layer and includes a water-insoluble and alkali-soluble resin and a development inhibitor, the solubility of the upper layer in an aqueous alkaline solution being increased by exposure to light, and at least one of the lower layer and the upper layer of the recording layer includes an infrared absorbent. According to the invention, there is provided is a positive planographic printing plate precursor which can provide a printing plate directly from scanning exposure based on digital signals and is excellent in printing durability and chemical resistance.

### CROSS-REFERENCE TO RELATED APPLICATION

This application claims priority under 35 USC 119 from Japanese Patent Application No. 2003-337085, the disclosure of which is incorporated by reference herein.

### BACKGROUND OF THE INVENTION

1. Field of the Invention

The present invention relates to a planographic printing plate precursor, and specifically to a positive type planographic printing plate precursor for the so-called “Computer To Plate (CTP)” system, from which a printing plate can directly be prepared on the basis of digital signals from a computer or the like.

2. Description of the Related Art

In recent years, the development of lasers has been remarkable. In particular, among solid lasers and semiconductor lasers having an emission wavelength within near infrared and infrared wavelength ranges, small-sized ones having a high output have become readily available. In the field of planographic printing, these lasers are very useful as light sources for exposure, used to prepare printing plates directly on the basis of digital data from a computer or the like.

Infrared-laser-applicable positive type planographic printing plate precursors comprise, as essential components, an alkali-soluble binder resin, an IR dye which absorbs light to generate heat, or the like. The IR dye or the like interacts with the binder resin in unexposed portions (image areas) of the precursor so as to function as a dissolution inhibitor for substantially lowering the solubility of the binder resin in a developer. On the other hand, in exposed portions (non-image areas), generated heat weakens the interaction of the IR dye or the like with the binder resin. Consequently, the exposed portions are dissolved in the alkaline developer, so as to form a planographic printing plate.

The image-forming capability of such infrared-laser-applicable positive planographic printing plate precursors depends on heat generated by infrared laser exposure of a recording surface. Therefore, in portions near a support, an amount of heat used to form images, that is, used to making the recording layer dissolvable, becomes small because of diffusion of heat to the support, so that the sensitivity of the portions becomes low. Accordingly, in the non-image areas of the recording layer, the effect of removing the capability of inhibiting the development of the areas cannot be sufficiently obtained so that a difference between the non-image areas and the image areas becomes small. Thus, the printing plate precursors have a problem in that highlight reproducibility thereof is insufficient.

In order to solve the problem concerning the highlight reproducibility, use of a recording layer made of material which makes it possible to develop non-image portions more easily, that is, material having a good solubility in an aqueous alkaline solution, has been considered. However, such a recording layer is chemically weak in its image areas as well. Thus, the recording layer has a problem of poor chemical resistance such that the recording layer is easily damaged by developer, ink-washing solvent used in printing, a plate cleaner, or the like. It is eagerly desired to develop resin material which is excellent in chemical resistance and durability of film in unexposed portions thereof, and is also excellent in developing property after the dissolution-inhibiting effect of the resin is cancelled by exposing the resin to light.

It is difficult to solve the above-mentioned problems by a mono-layered recording layer in which alkali-soluble resin or other components are appropriately selected. Therefore, a technology of a planographic printing plate precursor having a multi-layered recording layer composed of a lower layer comprising polyvinyl phenol resin and exhibiting superior alkali-solubility, and an upper layer comprising water-insoluble and alkali-soluble resin and an infrared absorbent and having solubility in aqueous alkaline solution which is largely increased by exposure to light is disclosed (see, for example, Japanese Patent Application Laid-Open (JP-A) No. 10-250255). Although this planographic printing plate precursor can achieve improved sensitivity, the precursor is insufficient in chemical resistance. The precursor also has a problem in that the adhesiveness between a support and the recording layer is insufficient so as to exhibit poor printing durability.

For similar purposes, various improved technology is suggested, such as an image forming material wherein a lower layer comprising a copolymer having a specified monomer and a photosensitive upper layer are laminated on a support (see, for example, JP-A No. 11-218914); and a printing plate production process using a planographic printing plate precursor wherein a lower layer comprising alkali soluble resin and an upper layer having infrared sensitivity and resistance against alkaline development are laminated on a hydrophilic support (see, for example, JP-A No. 11-194483). Although the former is superior in sensitivity and chemical resistance, the film strength of the resin used in the lower layer is insufficient, and thus there is room for improving printing durability. The latter has problems such that the recording layer elutes out by action of a solvent component contained in a plate cleaner since the alkali-soluble resin used is poor in chemical resistance, and that the solvent component penetrates into the interface between the lower layer and the support to lower the adhesiveness between the recording layer and the support, whereby the recording layer is easily peeled. Thus, it is difficult to make the printing durability of the precursor, which depends on the film strength of the lower layer, and the chemical resistance thereof compatible with each other.

### SUMMARY OF THE INVENTION

The present invention can solve the above-mentioned problems and attain the following objects.

An object of the invention is to provide a positive type planographic printing plate precursor which can provide a printing plate directly from scanning exposure based on digital signals and is excellent in printing durability and chemical resistance.

The present inventors have repeatedly conducted earnest research, and as a result, have found that the above-mentioned object can be attained by selecting, as a recording layer component of a planographic printing plate precursor, a water-insoluble and alkali-soluble resin having active hydrogen in the main chain thereof, whereby the invention was achieved.

A first aspect of the invention is to provide a planographic printing plate precursor which comprises a support, and a recording layer which is formed on the support and comprises a water-insoluble and alkali-soluble resin having active hydrogen in a main chain thereof, and an infrared absorbent, the solubility of the recording layer in an aqueous alkaline solution being increased by exposure to light.

A second aspect of the invention is to provide a planographic printing plate precursor which comprises a support, and a recording layer formed on the support, wherein the recording layer comprises a lower layer which is formed on the support and comprises a water-insoluble and alkali-soluble resin having active hydrogen in a main chain thereof, and an upper layer which is formed on the lower layer and comprises a water-insoluble and alkali-soluble resin and a development inhibitor, the solubility of the upper layer in an aqueous alkaline solution being increased by exposure to light, and at least one of the lower layer and the upper layer of the recording layer comprises an infrared absorbent.

The precise mechanism by which the present invention functions is unclear but is presumed to be as follows.

In the planographic printing plate precursor according to the first aspect of the invention, the recording layer comprises a water-insoluble and alkali-soluble resin having active hydrogen in the main chain thereof. Therefore, a property such that the main chains of molecules of the resin aggregate by action of hydrogen bonding originating from the active hydrogen atoms in the main chains is effectively exhibited. Thus, even if the recording layer is formed as a single film, the film strength thereof is superior. This contributes to improvement in the printing durability of the printing plate precursor.

As compared with known alkali-soluble resin, the resin used in the invention has superior resistance against dissolution in organic solvent or the like, and it is thought that for this reason the resin is not easily damaged by a plate cleaner or the like.

Furthermore, in areas of the recording layer wherein the effect of inhibiting development is cancelled by exposure to light (i.e., non-image areas of the recording layer), superior alkali-solubility of the above-mentioned water-insoluble and alkali-soluble resin (having active hydrogen in the main chain thereof) itself is expressed. It appears that the expression of superior alkali-solubility makes it possible to form a high-quality image having no remaining film.

In the case where a water-insoluble and alkali-soluble resin having active hydrogen in the main chain thereof is used in the lower layer of a multi-layered recording layer as in the planographic printing plate precursor according to the second aspect of the invention, in image areas, that is, in areas where the upper layer of the recording layer is present as an alkali-development resistant layer, the lower layer exhibits superior printing durability and chemical resistance since the above-mentioned high film strength and chemical resistance act effectively on the lower layer. It is also considered that when the upper layer is removed in the non-image areas, the lower layer is rapidly dissolved or dispersed in alkaline developer by action of the original alkali-solubility of the lower layer.

It is thus presumed that the multi-layered recording layer is superior in sensitivity and alkali resistance to any mono-layered recording layer due to excellent image-forming capability of the upper layer, the film property of components of the lower layer and high alkali-solubility thereof, thereby more remarkably exhibiting good printing durability and chemical resistance than in mono-layered recording layers, which is one of advantageous effects of the invention.

In short, according to the invention, it is possible to provide a positive planographic printing plate precursor which can produce a printing plate directly from scanning exposure based on digital signals and is excellent in printing durability and chemical resistance.

### BRIEF DESCRIPTION OF THE DRAWINGS

FIG. 1 is a schematic view illustrating an example of a mechanically surface-roughening apparatus used to produce a support for a planographic printing plate precursor according to the present invention.

FIG. 2 is a graph showing an example of an alternate electric current waveform used in electrochemical surface-roughening used to produce the support for the planographic printing plate precursor according to the invention.

FIG. 3 is a schematic view of a machine wherein two or more radial drum rollers are linked with each other, which machine is used in electrochemical surface-roughening used to produce the support for the planographic printing plate precursor according to the invention.

FIG. 4 is a schematic view of an electrolyzing machine used in two-step power-feeding electrolysis which can be applied to the production of the support for the planographic printing plate precursor according to the invention.

### DETAILED DESCRIPTION OF THE INVENTION

The present invention is described in detail hereinafter.

The planographic printing plate precursor according to the first aspect of the invention (hereinafter referred to as the “first planographic printing plate precursor”) comprises a support, and a recording layer which is formed on the support and comprises a water-insoluble and alkali-soluble resin having active hydrogen in a main chain thereof and an infrared absorbent, the solubility of the recording layer in aqueous alkaline solution being increased by exposure to light. This recording layer will occasionally be referred to as the “mono-layered recording layer” hereinafter.

In order to make the inhibition (dissolution inhibiting power) of the recording layer high, it is preferable to add a development inhibitor to the recording layer. In particular, in the case of using, as the infrared absorbent, one having no dissolution inhibiting power, the development inhibitor can be an important component for keeping the alkali resistance of image areas.

The planographic printing plate precursor according to a second aspect of the invention (hereinafter referred to as the “second planographic printing plate precursor”) comprises a support, and a recording layer formed on the support (which recording layer will occasionally be referred to as the “multi-layered recording layer hereinafter”), wherein the recording layer comprises a lower layer which is formed on the support and comprises a water-insoluble and alkali-soluble resin having active hydrogen in the main chain thereof, and an upper layer which is formed on the lower layer and comprises a water-insoluble and alkali-soluble resin and a development inhibitor, the solubility of the upper layer in aqueous alkaline solution being increased by exposure to light, and at least one of the lower layer and the upper layer of the recording layer comprises an infrared absorbent.

First, the water-insoluble and alkali-soluble resin having active hydrogen in the main chain thereof, which is an essential component of the first and second planographic printing plate precursors of the invention, will be described in detail.

[Water-Insoluble and Alkali-Soluble Resin Having Active Hydrogen in the Main Chain Thereof]

It is essential that the mono-layered recording layer and the multi-layered recording layer in the invention each comprise a water-insoluble and alkali-soluble resin having active hydrogen in the main chain thereof (hereinafter referred to as the “specific alkali-soluble resin” as the case may be).

The specific alkali-soluble resin used in the invention may be any resin that has a hydrogen atom dissociatable by action of alkali (i.e., active hydrogen) on any one of the atoms constituting the main chain thereof and that is soluble in aqueous alkaline solution. Since the hydrogen atom is dissociated from the specific alkali-soluble resin by only action of alkali, the resin is insoluble in water.

The dissociation constant pKₐ of the active hydrogen of the specific alkali-soluble resin is preferably 15 or less, more preferably 12 or less in order to express the alkali-solubility of the resin.

The active hydrogen is usually present on a nitrogen or carbon atom which constitutes the main chain, and is preferably present on the nitrogen atom. In order for the resin to have hydrogen-dissociating power by action of alkali, it is necessary that the resin has one or more electron withdrawing structures on one side or both sides of the atom having the active hydrogen.

Since the electron withdrawing structure(s) form(s) the main chain of the polymer together with the atom having the active hydrogen, the structure(s) is/are preferably one or more bivalent or higher-valent organic groups, and is/are more preferably one or more bivalent organic groups in order to form a linear polymerization compound. Preferable examples of the bivalent electron withdrawing organic groups include —CO—, and —SO₂—. In order for the resin to express alkali-solubility, it is preferable that one side of the atom having the active hydrogen is linked to —SO₂—.

As described above, the structure having the active hydrogen is made of a combination of the atom having the active hydrogen and one or more bivalent or higher-valent organic groups. Preferable examples of the combination used in the invention are as follows:

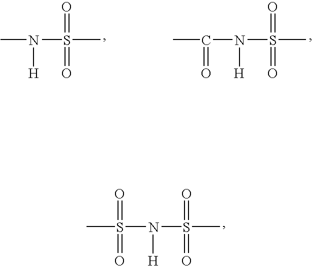

Each of these structures, which has active hydrogen, is combined with any other bivalent organic group than these structures, thereby forming a linear polymer compound. This linear polymer compound is one of the specific alkali-soluble resins used in the invention.

Specific examples of the method for producing the linear polymer compound include known condensing methods described in J. Polym. Sci. vol. 40, p. 389 (1959), J. Polym. Sci., Polym. Chem. Ed. vol. 17, p. 1483 (1979), J. Polym. Sci., Polym. Lett. Ed. vol. 15, p. 207 (1977), Makromal. Chem. vol. 179, p. 2081 (1978), and J. Polym. Sci., Polym. Chem. Ed. vol. 17, p. 2929 (1979), and other documents.

Specific and particularly preferable examples (P-1) to (P-15) of the specific alkali-soluble resin used in the invention are illustrated below. In the invention, however, the resin is not limited to these examples.

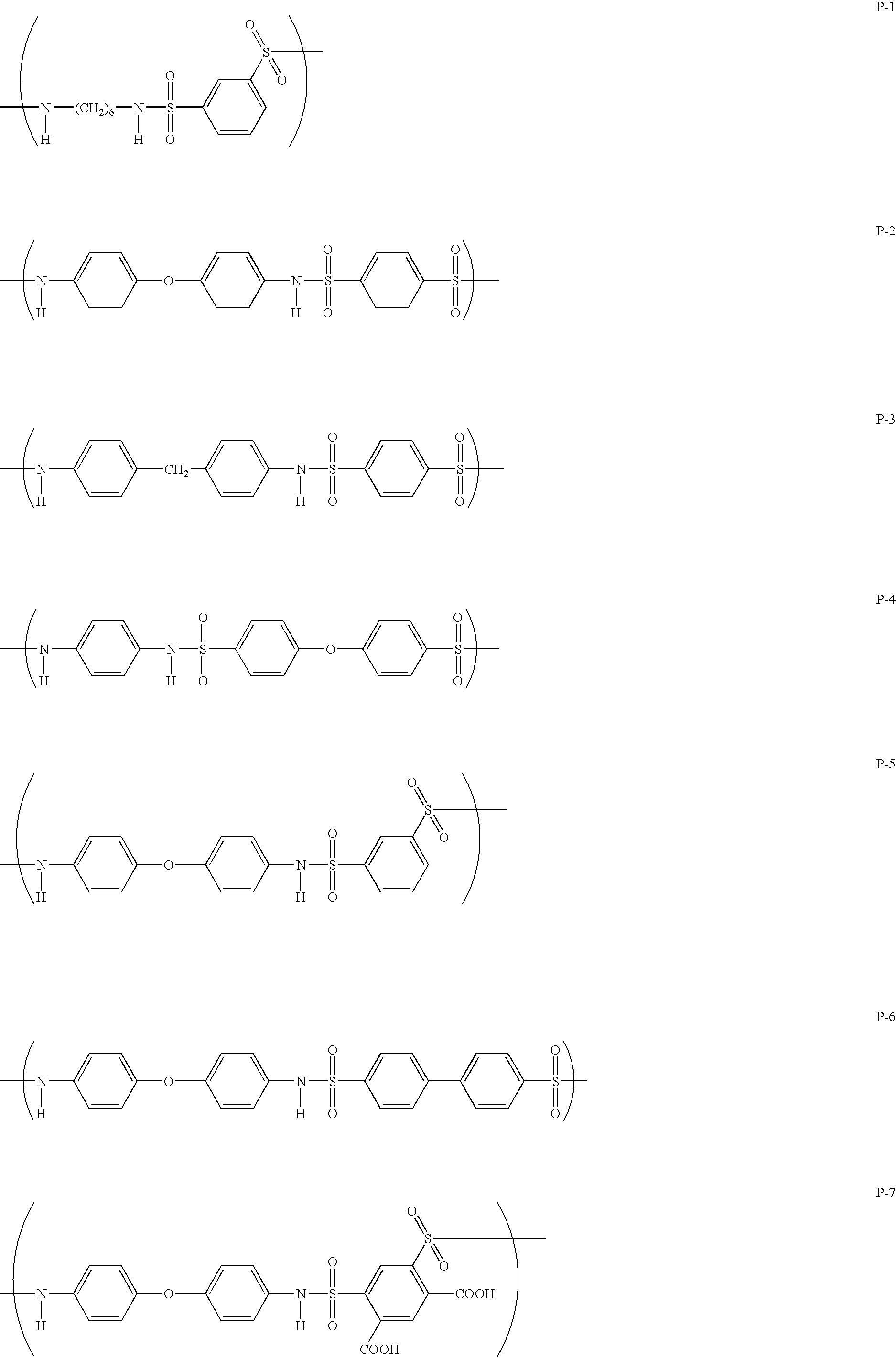

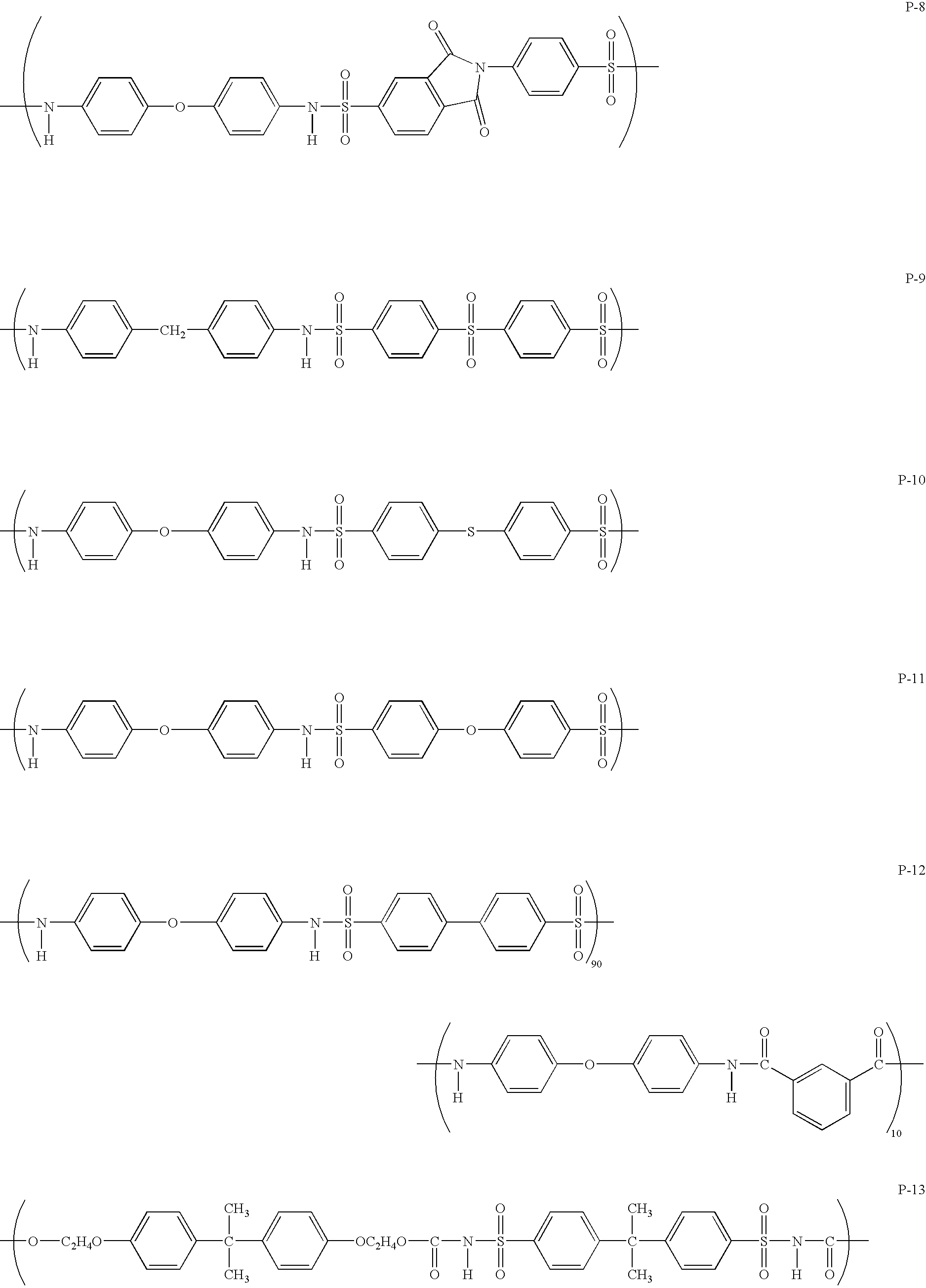

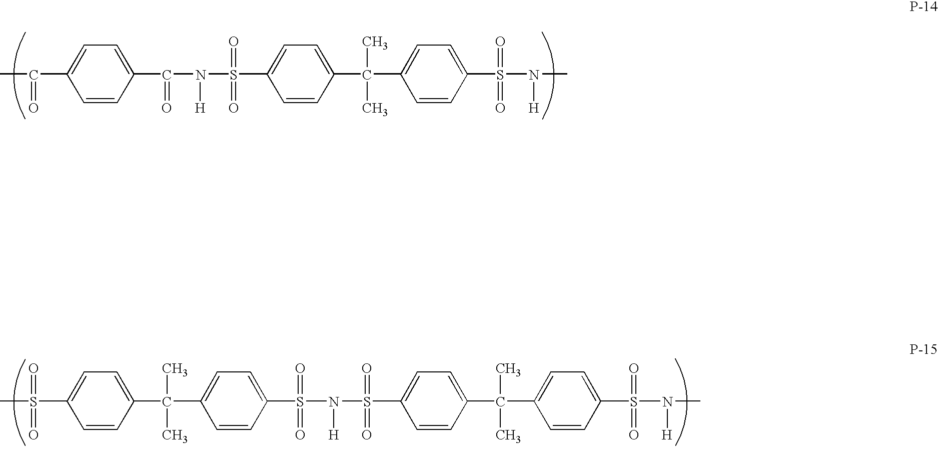

The specific alkali-soluble resin, which is related to the invention, is preferably a resin having a weight-average molecular weight (Mw) of 2,000 or more and a number-average molecular weight of 500 or more, and is more preferably a resin having a weight-average molecular weight of 5,000 to 300,000, a number-average molecular weight of 800 to 250,000, and a dispersion degree (the weight-average molecular weight/the number-average molecular weight) of 1.1 to 10.

These specific alkali-soluble resins may be used alone or in the form of a mixture of two or more thereof.

In the case of the mono-layered recording layer, the content by percentage of the specific alkali-soluble resin contained in the total solid components of the recording layer related to the invention is preferably from 5 to 90% by mass, more preferably from 10 to 85% by mass, most preferably from 50 to 80% by mass. In the case that the specific alkali-soluble resin is used in the lower layer of the multi-layered recording layer, the content by percentage thereof in the total solid components of the lower layer is preferably from about 50 to 95% by mass, more preferably from about 60 to 90% by mass.

Second Planographic Printing Plate Precursor of the Invention

The following describes, in detail, the second planographic printing plate precursor of the invention, that is, the planographic printing plate precursor having the multi-layered recording layer, which is a preferable embodiment of the invention.

It is necessary that the second planographic printing plate precursor of the invention comprises, in its lower layer adjacent to its support, the above-mentioned specific alkali-soluble resin.

[Lower Layer Comprising the Specific Alkali-Soluble Resin]

The lower layer related to the invention comprises the specific alkali-soluble resin. As described above, the specific alkali-soluble resin used herein may be any resin that is water-insoluble and alkali-soluble.

It is acceptable to use some other resin, besides the specific alkali-soluble resin, in the lower layer related to the invention as far as the effects of the invention are not disturbed. Since the lower layer itself needs to express alkali-solubility in non-image areas of this layer, it is necessary to select a resin which does not damage this property. From this viewpoint, the resin used together with the specific alkali-soluble resin may be a water-insoluble and alkali-soluble resin other than the specific alkali-soluble resin. Examples of the water-insoluble and alkali-soluble resin used together include alkali-soluble resins that are detailed below as a component of the upper layer. Particularly preferable examples thereof include polyamide resin, epoxy resin, polyacetal resin, acrylic resin, methacrylic resin, polystyrene resin, Novolak type phenol resin, and polyurethane resin.

The blend amount of the resin used together is preferably 50% by mass or less of the specific alkali-soluble resin.

If necessary, an infrared absorbent and other additives may be incorporated into the lower layer related to the invention. Examples of the other additives include a development accelerator, a surfactant, a printing-out agent/coloring agent, a plasticizer, and a wax agent. Details of types and amounts of the infrared absorbent and the other additives, and others are the same as described about components of the upper layer, which will be described later.

[Upper Layer Comprising a Water-Insoluble and Alkali-Soluble Resin and a Development Inhibitor, the Solubility of the Upper Layer in Aqueous Alkaline Solution Being Increased by Exposure to Light]

The upper layer related to the invention comprises a water-insoluble and alkali-soluble resin (which resin will occasionally be referred to simply as the “alkali-soluble resin”, hereinafter) and a developing accelerator, and further has solubility in an aqueous alkaline solution which is increased by exposure to light.

Respective components of the upper layer related to the invention are described hereinafter.

[Water-Insoluble and Alkali-Soluble Resin]

The alkali-soluble resin which can be used in the upper layer in the invention may be any alkali-soluble resin having a property that when the resin contacts alkaline developer, the resin is dissolved therein. The alkali-soluble resin is preferably: a homopolymer comprising, in a main chain and/or side chains thereof, an acidic group; a copolymer of such homopolymers; or a mixture thereof.

This alkali-soluble resin, which has an acidic group, may be in particular a polymer compound having, in a molecule thereof, one or more functional groups selected from a phenolic hydroxyl group (1), a sulfonamide group (2) and an active imide group (3). Examples thereof are illustrated below. In the invention, however, the alkali-soluble resin is not limited to these examples.

Examples of the polymer compound having a phenolic hydroxyl group (1) include Novolak resins such as phenol formaldehyde resin, m-cresol formaldehyde resin, p-cresol formaldehyde, m-/p-mixed cresol formaldehyde resin, and phenol/(m-, p- or m-/p-mixed) cresol mixed formaldehyde resin; and pyrogallol acetone resin. The polymer compound having a phenolic hydroxyl group (1) is preferably a polymer compound having a phenolic hydroxyl in a side chain thereof, besides the above resins. Examples of the polymer compound having a phenolic hydroxyl group in a side chain thereof include polymer compounds obtained by homopolymerizing a polymerizable monomer that is a low molecular weight compound having one or more phenolic hydroxyl groups and one or more polymerizable unsaturated bonds, or copolymerizing the monomer with a different polymerizable monomer.

Preferable examples of the polymerizable monomer having a phenolic hydroxyl group include acrylamide, methacrylamide, acrylic acid ester, and methacrylic acid ester which each have a phenolic hydroxyl group; and hydroxystyrene. Specific examples thereof include N-(2-hydroxyphenyl)acrylamide, N-(3-hydroxyphenyl)acrylamide, N-(4-hydroxyphenyl)acrylamide, N-(2-hydroxyphenyl)methacrylamide, N-(3-hydroxyphenyl)methacrylamide, N-(4-hydroxyphenyl)methacrylamide, o-hydroxyphenyl acrylate, m-hydroxyphenyl acrylate, p-hydroxyphenyl acrylate, o-hydroxyphenyl methacrylate, m-hydroxyphenyl methacrylate, p-hydroxyphenyl methacrylate, o-hydroxystyrene, m-hydroxystyrene, p-hydroxystyrene, 2-(2-hydroxyphenyl)ethyl acrylate, 2-(3-hydroxyphenyl)ethyl acrylate, 2-(4-hydroxyphenyl)ethyl acrylate, 2-(2-hydroxyphenyl)ethyl methacrylate, 2-(3-hydroxyphenyl)ethyl methacrylate, and 2-(4-hydroxyphenyl)ethyl methacrylate. The resins each having a phenolic hydroxyl group may be used in combination of two or more thereof. As described in U.S. Pat. No. 4,123,279, a copolymer of phenol having an alkyl group having 3 to 8 carbon atoms and formaldehyde may be used together. Examples of the copolymer include t-butylphenol formaldehyde resin, and octylphenol formaldehyde resin.

Examples of the alkali-soluble resin having a sulfonamide group (2) include polymer compounds obtained by homopolymerizing a polymerizable monomer having a sulfonamide group or copolymerizing the monomer with a different polymerizable monomer. Examples of the polymerizable monomer having a sulfonamide group include polymerizable monomers that are low molecular weight compounds which each have, in a single molecule thereof, one or more sulfonamide groups —NH—SO₂—, wherein at least one hydrogen atom is bonded to a nitrogen atom, and one or more polymerizable unsaturated bonds. Of these compounds, preferable are low molecular weight compounds which each have an acryloyl group, an allyl group, or a vinyloxy group and a substituted or mono-substituted aminosulfonyl group or substituted sulfonylimino group.

The alkali-soluble resin having an active imide group (3) is preferably a polymer compound having in a molecule thereof an active imide group. Examples of this polymer compound include polymer compounds obtained by homopolymerizing a polymerizable monomer that is a low molecular weight compound having, in a single molecule thereof, one or more active imide groups and one or more polymerizable unsaturated bonds or copolymerizing the monomer with a different polymerizable monomer.

Specific and preferable examples of such a compound include N-(p-toluenesulfonyl)methacrylamide and N-(p-toluenesulfonyl)acrylamide.

The alkali-soluble resin related to the invention is preferably a polymer compound obtained by polymerizing two or more out of the polymerizable monomer having a phenolic hydroxyl group, the polymerizable monomer having a sulfonamide group, and the polymerizable monomer having an active imide group. The copolymerization ratio between the polymerizable monomers and the combination of the polymerization monomers are not limited. In the case of copolymerizing the polymerizable monomer having a phenolic hydroxyl group with the polymerizable monomer having a sulfonamide group and/or the polymerizable monomer having an active imide group, the blend ratio of the former to the latter is preferably from 50:50 to 5:95, more preferably from 40:60 to 10:90.

Furthermore, the alkali-soluble resin related to the invention is preferably a polymer compound obtained by polymerizing one or more polymerizable monomers selected from the polymerizable monomer having a phenolic hydroxyl group, the polymerizable monomer having a sulfonamide group, and the polymerizable monomer having an active imide group with a different polymerizable monomer. About the copolymerization ratio in this case, the ratio of the monomer for giving alkali-solubility is preferably 10% or more by mole, more preferably 20% or more by mole from the viewpoint of the developing property of the recording layer.

Examples of the different polymerizable monomer which can be used herein include compounds listed up in the following items (m1) to (m12). In the invention, however, the monomer is not limited to these examples.
(m1) Acrylic acid esters and methacrylic acid esters having an aliphatic hydroxyl group, such as 2-hydroxyethyl acrylate and 2-hydroxyethyl methacrylate.
(m2) Alkyl acrylates, such as methyl acrylate, ethyl acrylate, propyl acrylate, butyl acrylate, amyl acrylate, hexyl acrylate, octyl acrylate, benzyl acrylate, 2-chloroethyl acrylate, and glycidyl acrylate.
(m3) Alkyl methacrylate, such as methyl methacrylate, ethyl methacrylate, propyl methacrylate, butyl methacrylate, amyl methacrylate, hexyl methacrylate, cylohexyl methacrylate, benzyl methacrylate, 2-chloroethyl methacrylate, and glycidyl methacrylate.
(m4) Acrylamides or methacrylamides, such as acrylamide, methacrylamide, N-methylolacrylamide, N-ethylacrylamide, N-hexylmethacrylamide, N-cyclohexylacrylamide, N-hydroxyethylacrylamide, N-phenylacrylamide, N-nitrophenylacrylamide, and N-ethyl-N-phenylacrylamide.
(m5) Vinyl ethers, such as ethyl vinyl ether, 2-chloroethyl vinyl ether, hydroxyethyl vinyl ether, propyl vinyl ether, butyl vinyl ether, octyl vinyl ether, and phenyl vinyl ether.
(m6) Vinyl esters, such as vinyl acetate, vinyl chloroacetate, vinyl butyrate, and vinyl benzoate.
(m7) Styrenes, such as styrene, α-methylstyrene, methylstyrene, and chloromethylstyrene.
(m8) Vinyl ketones, such as methyl vinyl ketone, ethyl vinyl ketone, propyl vinyl ketone, and phenyl vinyl ketone.
(m9) Olefins, such as ethylene, propylene, isobutylene, butadiene, and isoprene.
(m10) N-vinylpyrrolidone, acrylonitrile, methacrylonitrile, and so on.
(m11) Unsaturated imides, such as maleimide, N-acryloylacrylamide, N-acetylmethacrylamide, N-propionylmethacrylamide, and N-(p-chlorobenzoyl)methacrylamide.
(m12) Unsaturated carboxylic acids, such as acrylic acid, methacrylic acid, maleic anhydride, and itaconic acid.

In the case that the alkali-soluble resin related to the invention is a homopolymer or copolymer made from the polymerizable monomer having a phenolic hydroxyl group, the polymerizable monomer having a sulfonamide group and the polymerizable monomer having an active imide group, the homopolymer or copolymer is preferably a polymer having a weight-average molecular weight of 2,000 or more and a number-average molecular weight of 500 or more, more preferably a polymer having a weight-average molecular weight of 5,000 to 300,000, a number-average molecular weight of 800 to 250,000 and a dispersion degree (the weight-average molecular weight/the number-average molecular weight) of 1.1 to 10.

In particular, in the case that the alkali-soluble resin related to the invention is a phenol formaldehyde resin, a cresol aldehyde resin or the like, the resin is preferably a resin having a weight-average molecular weight of 500 to 20,000 and a number-average molecular weight of 200 to 10,000.

The alkali-soluble resin used in the invention is desirably any one of resins each having a phenolic hydroxyl group since strong hydrogen bonding is generated in unexposed portions of the resin while in exposed portion thereof a part of hydrogen bonds is easily cancelled. Of the resins having a phenolic hydroxy group, Novolak resin is particularly preferable.

In the invention, two or more alkali-soluble resins having different rates of dissolution in aqueous alkaline solution may be mixed with the resin having a phenolic hydroxyl group. In the case, the blend ratio therebetween is arbitrary. The alkali-soluble resin mixed with the resin having a phenolic hydroxyl group is preferably an acrylic resin, more preferably an acrylic resin having a sulfonamide group since the acrylic resin is low in compatibility with the resin having a phenolic hydroxyl group.

The content by percentage of the alkali-soluble resin(s) in all solid contents of the upper layer related to the invention is in total from 50 to 98% by mass from the viewpoints of the endurance of the recording layer, the sensitivity thereof, and others.

[Development Inhibitor]

It is indispensable that a development inhibitor is incorporated into the upper layer related to the invention in order to make the inhibition (dissolution inhibiting power) thereof high.

This development inhibitor may be any development inhibitor that interacts with the above-mentioned alkali-soluble resin to lower the solubility of the alkali-soluble resin in developer substantially in unexposed portions of the recording layer while in exposed portions thereof the interaction weakens so that the exposed portions can be dissolved in the developer. The developing inhibitor is preferably a quaternary ammonium salt, a polyethylene glycol type compound or the like. Some examples of an infrared absorbent and an image coloring agent that will be described later function as the development inhibitor. These are also preferable.

The quaternary ammonium salt is not limited to specific kinds, and examples thereof include tetraalkylammonium, trialkylarylammonium, dialkyldiarylammonium, alkyltriarylammonium, tetaraarylammonium, cyclic ammonium, and bicyclic ammonium salts.

Specific examples thereof include tetrabutylammonium bromide, tetrapentylammonium bromide, tetrahexylammonium bromide, tetraoctylammonium bromide, tetralaurylammonium bromide, tetraphenylammonium bromide, tetranaphthylammonium bromide, tetrabutylammonium chloride, tetrabutylammonium iodide, tetrastearylammonium bromide, lauryltrimethylammonium bromide, stearyltrimethylammonium bromide, behenyltrimethylammonium bromide, lauyrltriethylammonium bromide, phenyltrimethylammonium bromide, 3-trifluoromethylphenyltrimethylammonium bromide, benzyltrimethylammonium bromide, dibenzyldimethylammonium bromide, distearyldimethylammonium bromide, tristearylmethylammonium bromide, benzyltriethylammonium bromide, hydroxyphenyltrimethylammonium bromide, and N-methylpyridinium bromide. Quaternary ammonium salts described in Japanese Patent Applications Nos. 2001-226297, 2001-370059 and 2001-398047 are particularly preferable.

The added amount of the quaternary ammonium salt is preferably from 0.1 to 50% by mass, more preferably from 1 to 30% by mass of all solid contents of the upper layer from the viewpoints of the development-inhibiting effect of the salt and the film-formability of the alkali-soluble resin.

The polyethylene glycol type compound is not limited to specific kinds, and may be a compound having a structure represented by the following general formula (I):
R¹—{—O—(R³—O—)ₘ—R²}ₙ (I)
wherein R¹ represents a polyhydric alcohol residue or polyhydric phenol residue; R² represents a hydrogen atom, or an alkyl, alkenyl, alkynyl, alkyloyl, aryl or aryloyl group which may each have a substituent and each have 1 to 25 carbon atoms; R³ represents an alkylene group which may have a substituent; m and n are an integer of 10 or more and an integer of 1 or more and 4 or less, respectively, on average.

Examples of the polyethylene glycol type compound represented by the general formula (I) include polyethylene glycols, polypropylene glycols, polyethylene glycol alkyl ethers, polypropylene glycol alkyl ethers, polyethylene glycol aryl ethers, polypropylene glycol aryl ethers, polyethylene glycol alkylaryl ethers, polypropylene glycol alkylaryl ethers, polyethylene glycol glycerin esters, polypropylene glycol glycerin esters, polyethylene sorbitol esters, polypropylene glycol sorbitol esters, polyethylene glycol aliphatic acid esters, polypropylene glycol aliphatic acid esters, polyethylene glycolized ethylenediamines, polypropylene glycolized ethylenediamines, polyethylene glycolized diethylenetriamine, and polypropylene glycolized diethylenetriamines.

Specific examples thereof include polyethylene glycol 1000, polyethylene glycol 2000, polyethylene glycol 4000, polyethylene glycol 10000, polyethylene glycol 20000, polyethylene glycol 5000, polyethylene glycol 100000, polyethylene glycol 200000, polyethylene glycol 500000, polypropylene glycol 1500, polypropylene glycol 3000, polypropylene glycol 4000, polyethylene glycol methyl ether, polyethylene glycol ethyl ether, polyethylene glycol phenyl ether, polyethylene glycol dimethyl ether, polyethylene glycol diethyl ether, polyethylene glycol diphenyl ether, polyethylene glycol lauryl ether, polyethylene glycol dilauryl ether, polyethylene glycol nonyl ether, polyethylene glycol cetyl ether, polyethylene glycol stearyl ether, polyethylene glycol distearyl ether, polyethylene glycol behenyl ether, polyethylene glycol dibehenyl ether, polypropylene glycol methyl ether, polypropylene glycol ethyl ether, polypropylene glycol phenyl ether, polypropylene glycol dimethyl ether, polypropylene glycol diethyl ether, polypropylene glycol diphenyl ether, polypropylene glycol lauryl ether, polypropylene glycol dilauryl ether, polypropylene glycol nonyl ether, polyethylene glycol acetyl ester, polyethylene glycol diacetyl ester, polyethylene glycol benzoic acid ester, polyethylene glycol lauryl ester, polyethylene glycol dilauryl ester, polyethylene glycol nonylic acid, polyethylene glycol cetylic acid ester, polyethylene glycol stearoyl ester, polyethylene glycol distearoyl ester, polyethylene glycol behenic acid ester, polyethylene glycol dibehenic acid ester, polypropylene glycol acetyl ester, polypropylene glycol diacetyl ester, polypropylene glycol benzoic acid ester, polypropylene glycol dibenzoic acid ester, polypropylene glycol lauric acid ester, polypropylene glycol dilauric acid ester, polypropylene glycol nonylic acid ester, polyethylene glycol glycerin ether, polypropylene glycol glycerin ether, polyethylene glycol sorbitol ether, polypropylene glycol sorbitol ether, polyethylene glycolized ethylenediamine, polypropylene glycolized ethylendiamine, polyethylene glycolized diethylenetriamine, polypropylene glycolized diethylenetriamine, and polyethylene glycolized pentamethylenehexamine.

The added amount of the polyethylene glycol compound is preferably from 0.1 to 50% by mass, more preferably from 1 to 30% by mass of all solid contents of the upper layer from the viewpoints of the development-inhibiting effect of the compound and the film-formability of the recording layer.

In the case that such manners for making the inhibition (dissolution inhibiting power) high are adopted, the sensitivity of the recording layer lowers. In this case, it is effective for suppressing the low in the sensitivity to add a lactone compound to the upper layer. It appears that when developer penetrates into exposed portions of the recording layer, that is, areas thereof where the inhibition is cancelled, this lactone compound reacts with the developer to generate a new carboxylic acid compound, whereby the dissolution of the exposed areas of the recording layer is promoted to improve the sensitivity. In the unexposed areas, this lactone compound interacts with polar groups of the alkali-soluble resin, for example, hydroxyl groups of Novolak resin, and further the compound is present stably in the film because of its bulky structure having the lactone ring; therefore, even if alkaline developer contacts the surface of the unexposed portions, the development resistance of the areas does not lower since rapid ring-opening reaction of the lactone ring is restrained during the developing treatment. This interaction is more easily cancelled by exposure to light or heat than the inhibiting effect of the above-mentioned dissolution inhibitor. Consequently, the ring-opening reaction of the lactone compound advances rapidly in the exposed portions.

Such a lactone compound is not limited to specific kinds. Examples thereof include compounds by the following general formulae (L-I) and (L-II):

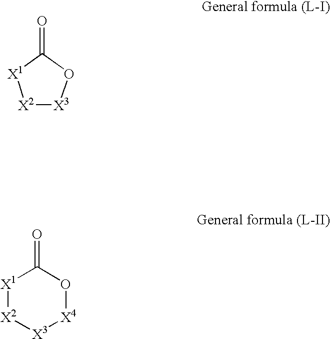

In the general formulae (L-I) and (L-II), X¹, X², X³ and X⁴ may be the same or different, and each represent a bivalent nonmetallic atom or nonmetallic atomic group which constitutes a part of the ring. These may each independently have a substituent. It is preferable that at least one of X¹, X² and X³ in the general formula (L-I), and at least one of X¹, X², X³ and X⁴ in the general formula (L-II) are each an electron withdrawing substituent or a substituent substituted with an electron withdrawing group.

The nonmetallic atom or nonmetallic atomic group is preferably an atom or atomic group selected from methylene, sulfinyl, carbonyl, thiocarbonyl, and sulfonyl groups, and sulfur, oxygen and selenium atoms, and is more preferably an atomic group selected from methylene, carbonyl and sulfonyl groups.

The electron withdrawing substituent (or group) referred to in the invention means a group having a positive Hammett substituent constant σp. About the Hammett substituent constant, the following can be referred to: Journal of Medicinal Chemistry, 1973, Vol. 16, No. 11, 1207-1216, and so on. Examples of the electron withdrawing group having a positive Hammett substituent constant op include halogen atoms (such as a fluorine atom (σp value: 0.06), a chlorine atom (up value: 0.23), a bromine atom (σp value: 0.23) and a iodine atom (σp value: 0.18)); trihaloalkyl groups (such as tribromomethyl (σp value: 0.29), trichloromethyl (σp value: 0.33), and trifluoromethyl (σp value: 0.54)); a cyano group (op value: 0.66); a nitro group (σp value: 0.78); aliphatic, aryl or heterocyclic sulfonyl groups (such as methanesulfonyl (σp value: 0.72)); aliphatic, aryl or heterocyclic acyl groups (such as acetyl (σp value: 0.50) and benzoyl (σp value: 0.43)); alkynyl groups (such as C CH (up value: 0.23)); aliphatic, aryl or heterocyclic oxycarbonyl groups (such as methoxycarbonyl (σp value: 0.45) and phenoxycarbonyl (σp value: 0.44)); and a carbamoyl group (σp value: 0.36); a sulfamoyl group (σp value: 0.57); a sulfoxide group; heterocyclic groups; an oxo group; and a phosphoryl groups.

Preferable examples of the electron withdrawing group include an amide group, an azo group, a nitro group, fluoroalkyl groups having 1 to 5 carbon atoms, a nitrile group, alkoxycarbonyl groups having 1 to 5 carbon atoms, acyl groups having 1 to 5 carbon atoms, alkylsulfonyl groups having 1 to 9 carbon atoms, arylsulfonyl groups having 6 to 9 carbon atoms, alkylsulfinyl groups having 1 to 9 carbon atoms, arylsulfinyl groups having 6 to 9 carbon atoms, arylcarbonyl groups having 6 to 9 carbon atoms, thiocarbonyl groups, fluorine-containing alkyl groups having 1 to 9 carbon atoms, fluorine-containing aryl groups having 6 to 9 carbon atoms, fluorine-containing allyl groups having 3 to 9 carbon atoms, an oxo group, and halogen atoms. More preferable examples of the electron withdrawing group include a nitro group, fluoroalkyl groups having 1 to 5 carbon atoms, a nitrile group, alkoxycarbonyl groups having 1 to 5 carbon atoms, acyl groups having 1 to 5 carbon atoms, arylsulfonyl groups having 6 to 9 carbon atoms, arylcarbonyl groups having 6 to 9 carbon atoms, an oxo group, and halogen atoms.

Specific examples of the compounds represented by the general formulae (L-I) and (L-II) are illustrated below. In the invention, however, the compounds are not limited to these compounds.

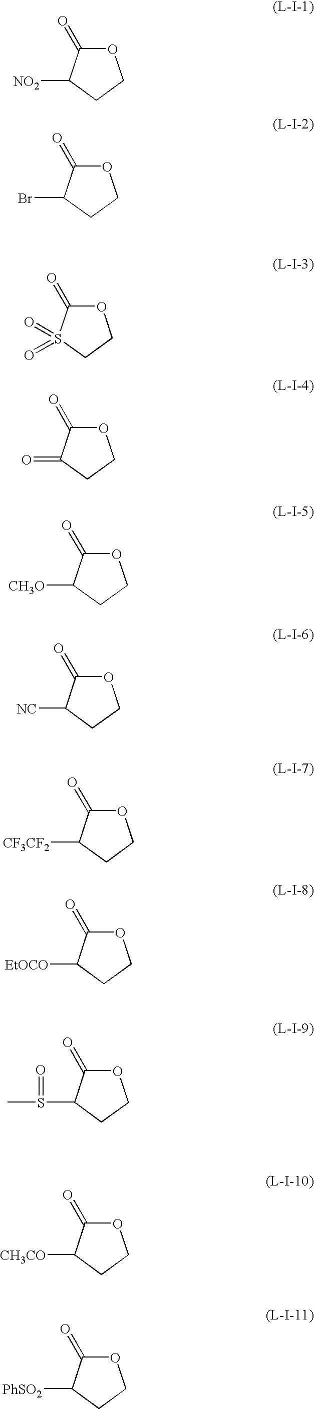

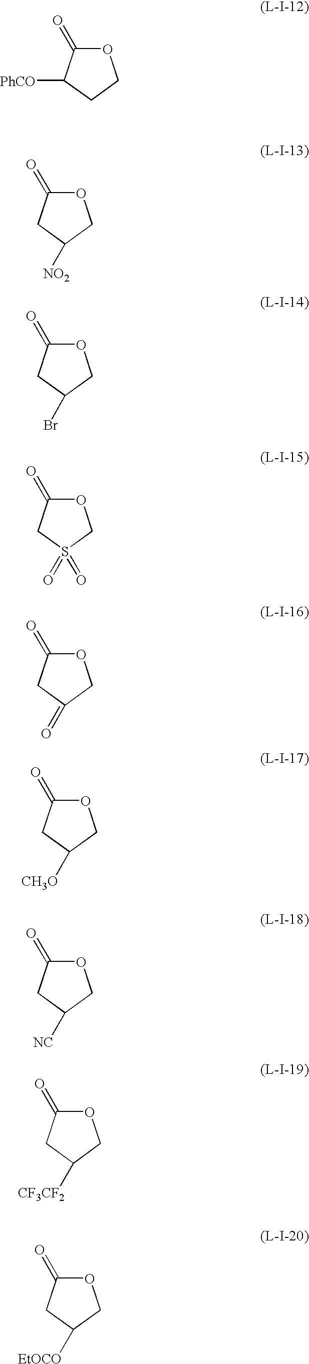

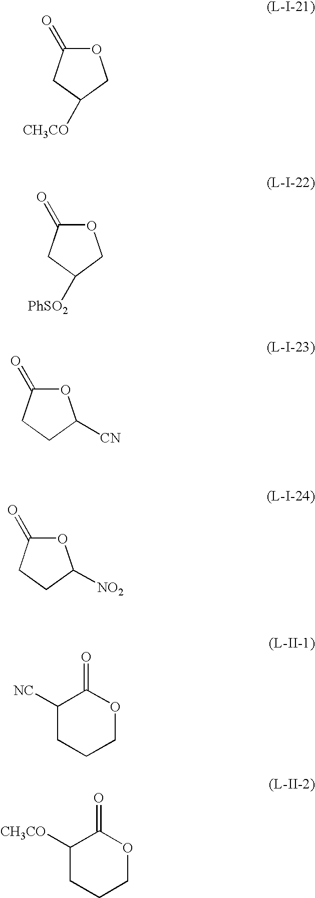

The added amount of the compounds represented by the general formulae (L-I) and (L-II) is preferably from 0.1 to 50% by mass, more preferably from 1 to 30% by mass of all solid contents of the upper layer from the viewpoints of the validity of the addition and the image-forming effect of the recording layer. If the amount is less than 0.1% by mass, the effects based on the addition are small. If the amount is more than 50% by mass, the image-forming effect is poor.

The lactone compounds in the invention may be used alone or in combination of two or more thereof. In the case of using two or more out of the compounds represented by the general formula (L-I) or the compounds represented by the general formula (L-II), the ratio between the added amounts of the two or more compounds may be arbitrary if the total added amount of the compounds is within the above-mentioned range.

In order to improve the inhibition of the image areas into developer, use is made of a substance which is thermally decomposable and further lowers the solubility of the alkali-soluble resin substantially in the state that the substance is not thermally decomposed. Examples of the substance include onium compounds, quinonediazide compounds (o-quinonediazide compounds), and aromatic sulfone compounds, aromatic sulfonic acid esters. These substances may be used alone or together with the above-mentioned quaternary ammonium salt, or polyethylene glycol type compound.

Examples of the onium salts used in the invention include diazonium salts, ammonium salts, phosphonium salts, iodonium salts, sulfonium salts, selenonium salts, and arseninum salts. Particularly preferable examples thereof include diazonium salts described in S. I. Schlesinger, Photogr. Sci. Eng., 18, 387 (1974), T. S. Bal et al., Polymer, 21, 423 (1980), and JP-A No. 5-158230; ammonium salts described in U.S. Pat. Nos. 4,069,055 and 4,069,056, and JP-A No. 3-140140; phosphonium salts described in D. C. Necker et al, Macromolecules, 17, 2468 (1984), C. S. Wen et al., The, Proc. Conf. Rad. Curing ASIA p.478, Tokyo, Oct. (1988), and U.S. Pat. Nos. 4,069,055 and 4,069,056; iodonium salts described in J. V. Crivello et al., Macromolecules, 10(6), 1307 (1977), Chem. & Eng. News, Nov. 28, p.31 (1988), EP No. 104,143, U.S. Pat. No. 5,041,358, EP No. 4,491,628, and JP-A Nos. 2-150848 and 2-296514; sulfonium salts described in J. V. Crivello et al., Polymer J. 17, 73 (1985), J. V. Crivello et al., J. Org. Chem., 43, 3055 (1978), W. R. Watt et al., J. Polymer Sci., Polymer Chem. Ed., 22, 1789 (1984), J. V. Crivello et al., Polymer Bull., 14, 279 (1985), J. V. Crivello et al., Macromolecules, 14 (5), 1141 (1981), J. V. Crivello et al., J. Polymer Sci., Polymer Chem. Ed., 17, 2877 (1979), EP Nos. 370,693, 233,567, 297,443 and 297,442, U.S. Pat. Nos. 4,933,377, 3,902,114, 4,491,628, 4,760,013, 4,734,444 and 2,833,827, and DE Patents Nos. 2,904,626, 3,604,580, 3,604,581; selenonium salts described in J. V. Crivello et al., Macromolecules, 10 (6), 1307 (1977), J. V. Crivello et al., J. Polymer Sci., Polymer Chem. Ed., 17, 1047 (1979); and arsenonium slats described in C. S. Wen et al., The, Proc. Conf. Rad. Curing ASIA p.478 Tokyo, Oct. (1988).

Of these onium salts, diazonium salts are particularly preferable. Particularly preferable examples of the diazonium salts include salts described in JP-A No. 5-158230.

Examples of the counter ion for the onium salt include tetrafluoroboric acid, hexafluorophosphoric acid, triisopropylnaphthalenesulfonic acid, 5-nitro-o-toluenesulfonic acid, 5-sulfosalicylic acid, 2,5-dimethylbenzenesulfonic acid, 2,4,6-trimethylbenzenesulfonic acid, 2-nitrobenzenesulfonic acid, 3-chlorobenzenesulfonic acid, 3-bromobenzenesulfonic acid, 2-fluorocaprylnaphthalenesulfonic acid, dodecylbenzenesulfonic acid, 1-naphthol-5-sulfonic acid, 2-methoxy-4-hydroxy-5-benzoyl-benzenesulfonic acid, and paratoluenesulfonic acid ions. Of these examples, alkylaromatic sulfonic acid ions are preferable, examples of which include hexafluorophosphoric acid, triisopropylnaphthalenesulfonic acid, and 2,5-dimethylbenzenesulfonic acid ions.

The added amount of the onium salt is preferably from 0.1 to 50% by mass, more preferably from 0.5 to 30% by mass, even more preferably from 1.0 to 20% by mass of all solid contents of the upper layer.

The above-mentioned onium salts may be used alone or in a mixture form.

The quinonediazide compounds are preferably o-quinonediazide compounds. The o-quinonediazide compounds are compounds which each have at least one o-quinonediazide group and each have alkali-solubility increased by being thermally decomposed, and which may have various structures. In other words, the o-quinonediazide compounds assist the dissolution of the upper layer by both of the effect that the compounds are thermally decomposed so that their inhibition for the developing inhibitor is lost and the effect that the o-quinonediazide compounds themselves change to alkali-soluble substances.

Such an o-quinonediazide compound may be, for example, a compound described in J Cohser “Light-Sensitive Systems” (John & Wiley & Sons. Inc.), pp. 339-352. Particularly preferable is a sulfonic acid ester or sulfonamide of o-quinonediazide, which is obtained by reacting the o-quinonediazide with an aromatic polyhydroxy compound or aromatic amino compound. Preferable are also an ester made from benzoquinone-(1,2)-diazidesulfonic acid chloride or naphthoquinone-(1,2)-diazide-5-sulfonic acid chloride and pyrogallol-acetone resin, described in Japanese Patent Application Laid-Open (JP-B) No. 43-28403; an ester made from benzoquinone-(1,2)-diazidesulfonic acid chloride or naphthoquinone-(1,2)-diazide-5-sulfonic acid chloride and phenol-formaldehyde resin, described in U.S. Pat. Nos. 3,046,120 and 3,188,210.

Furthermore, preferable are an ester made from naphthoquinone-(1,2)-diazide-4-sulfonic acid chloride and phenol formaldehyde resin or cresol-formaldehyde resin, and an ester made from naphthoquinone-(1,2)-diazide-4-sulfonic acid chloride and pyrogallol-acetone resin. Other useful o-quinonediazide compounds are reported and disclosed in many examined or unexamined patent documents, for example, JP-A Nos. 47-5303, 48-63802, 48-63803, 48-96575, 49-38701 and 48-13354, JP-B Nos. 41-11222, 45-9610 and 49-17481, U.S. Pat. Nos. 2,797,213, 3,454,400, 3,544,323, 3,573,917, 3,674,495 and 3,785,825, GB Patents Nos. 1,227,602, 1,251,345, 1,267,005, 1,329,888 and 1,330,932, and DE Patent No. 854,890.

The added amount of the o-quinonediazide compound is preferably from 1 to 50% by mass, more preferably from 5 to 30% by mass, even more preferably from 10 to 30% by mass of all solid contents of the upper layer. The above-mentioned o-quinonediazide compounds may be used alone or in a mixture form.

The recording layer may contain an alkali-soluble resin at least one part of which is esterified, as described in JP-A No. 11-288089.

In order to promote the inhibition of the recording layer surface and reinforce the resistance against injures in the surface, the upper layer preferably contains a polymer made from a (meth)acrylate monomer having in the molecule thereof two or three perfluoroalkyl groups having 3 to 20 carbon atoms as described in JP-A No. 2000-187318.

The added amount thereof is preferably from 0.1 to 10% by mass, more preferably from 0.5 to 5% by mass of all solid contents of the upper layer.

[Infrared Absorbent]

In the second planographic printing plate precursor of the invention, it is indispensable to add an infrared absorbent to at least one of the upper and lower layers of the recording layer. The infrared absorbent may be any dye that absorbs infrared rays to generate heat, and may be selected from various dyes known as an infrared absorbent.

The infrared absorbent related to the invention may be a commercially available infrared absorbent or a known infrared absorbent described in documents (for example, “Dye Handbook” edited by the Society of Organic Synthesis Chemistry, Japan and published in 1970). Specific examples thereof include azo dyes, metal complex azo dyes, pyrrazolone azo dyes, anthraquinone dyes, phthalocyanine dyes, carbonium dyes, quinoneimine dyes, methine dyes, and cyanine dyes. Of these dyes, dyes which absorb infrared rays or near infrared rays are particularly preferable in the invention since they are suitable for being used to lasers which emit infrared rays or near infrared rays.

Examples of the dyes which absorb infrared rays or near infrared rays include cyanine dyes described in JP-A Nos. 58-125246, 59-84356, 59-202829 and 60-78787; methine dyes described in JP-A Nos. 58-173696, 58-181690 and 58-194595; naphthoquinone dyes described in JP-A Nos. 58-112793, 58-224793, 59-48187, 59-73996, 60-52940 and 60-63744; squarylium salts described in JP-A No. 58-112792; and cyanine dyes described in GB Patent No. 434,875.

A near infrared absorptive sensitizer described in U.S. Pat. No. 5,156,938 is also preferably used, and the following are particularly preferably used: substituted arylbenzo(thio)pyrylium salts described in U.S. Pat. No. 3,881,924, trimethinethiapyrylium salts described in JP-A No. 57-142645 (U.S. Pat. No. 4,327,169), pyrylium compounds described in JP-A Nos. 58-181051, 58-220143, 59-41363, 59-84248, 59-84249, 59-146063, and 59-146061, cyanine dyes described in JP-A No. 59-216146, pentamethinethiopyrylium salts described U.S. Pat. No. 4,283,475, pyrylium compounds described in JP-B Nos. 5-13514 and 5-19702; dyes (trade name: Epolight III-178, Epolight III-130 and Epolight III-125) manufactured by Epolin Inc. as commercially available products; and others.

Other particularly preferable examples of the infrared absorbent include near infrared absorptive dyes represented by the formulae (I) and (II) described in the specification of U.S. Pat. No. 4,756,993.

The infrared absorbent is preferably added to the upper layer of the recording layer or the vicinity of the upper layer from the viewpoint of the sensitivity thereof. In particular, when a dye having dissolution inhibiting power (such as a cyanine dye), together with the above-mentioned alkali-soluble resin, is added thereto, the sensitivity can be made high and simultaneously exposed portions can be caused to have resistance against dissolution in alkali. The infrared absorbent may be added to the lower layer or both of the upper and lower layers. The addition thereof to the lower layer makes it possible to make the sensitivity higher. When the infrared absorbent(s) is/are added to both of the upper and lower layers, a single compound or different compounds may used as the infrared absorbent(s).

The infrared absorbent may be added to the recording layer itself, or added to a layer different from the recording layer. In the case that the infrared absorbent is added to the different layer, the different layer is preferably a layer adjacent to the recording layer.

In the case that the infrared absorbent is a compound having dissolution inhibiting power, the infrared absorbent is preferably incorporated into the same layer as contains the alkali-soluble resin since the infrared absorbent has not only light to heat conversion function but also function as the above-mentioned development inhibitor.

When the infrared absorbent is added to the upper layer, the added amount of the infrared absorbent may be from 0.01 to 30% by mass, preferably from 0.1 to 20% by mass, more preferably from 1.0 to 10% by mass of all solid contents of the upper layer from the viewpoints of the sensitivity and the endurance (film properties) of the recording layer.

When the infrared absorbent is added to the lower layer, the added amount of the infrared absorbent may be from 0 to 20% by mass, preferably from 0 to 10% by mass, more preferably from 0 to 5% by mass of all solid contents of the lower layer. In the case that the infrared absorbent is added to the lower layer, by use of an infrared absorbent having dissolution inhibiting power as the infrared absorbent, the solubility of the lower layer is lowered. On the other hand, the use causes the infrared absorbent to generate heat when the infrared absorbent is exposed to an infrared laser, so that the solubility of the lower layer can be expected to be improved by the heat. Considering the balance therebetween, compounds to be added and amounts thereof should be selected. In areas having a thickness of 0.2 to 0.3 μm near the support, heat generated at the time of the exposure diffuses to the support. Thus, the effect of improving the solubility, based on the heat, is not easily obtained so that the fall in the solubility of the lower layer, based on the addition of the infrared absorbent, may cause a fall in the sensitivity. Accordingly, the added amount such that the dissolution rate of the lower layer in developer (25 to 30° C.) is below 30 nm/sec. is not preferable even if the added amount is within the above-mentioned range.

[Other Additives]

When the lower and upper layers of the recording layer are formed, various additives besides the above-mentioned essential components can be optionally added thereto as far as the advantageous effects of the invention are not damaged. The additives described below may be added to only the lower layer, only the upper layer, or to both of them.

(Development Promoter)

An acid anhydride, a phenolic compound, or an organic acid may be added to the upper layer and/or the lower layer, which constitutes the recording layer related to the invention, in order to promote the development thereof and improve the sensitivity.

The acid anhydride is preferably a cyclic acid anhydride. Specific examples of the cyclic acid anhydride include phthalic anhydride, tetrahydrophthalic anhydride, hexahydrophthalic anhydride, 3,6-endooxy-tetrahydrophthalic anhydride, tetrachlorophthalic anhydride, maleic anhydride, chloromaleic anhydride, α-phenylmaleic anhydride, succinic anhydride and pyromellitic anhydride, described in U.S. Pat. No. 4,115,128. The anhydride in an acyclic form is, for example, acetic anhydride.

Examples of the phenolic compound include bisphenol A, 2,2′-bishydroxysulfone, p-nitrophenol, p-ethoxyphenol, 2,4,4′-trihydroxybenzophenone, 2,3,4-trihydroxybenzophenone, 4-hydroxybenzophenone, 4,4′,4″-trihydroxytriphenylmethane, and 4,4′,3″,4″-tetrahydroxy-3,5,3′,5′-tetramethyltriphenylmethane.

Examples of the organic acid include sulfonic acids, sulfonic acids, alkylsulfuric acids, phosphonic acids, phosphoric acid esters, and carboxylic acids, described in JP-A Nos. 60-88942 and 2-96755. Specific examples thereof include p-toluenesulfonic acid, dodecylbenzenesulfonic acid, p-toluenesulfinic acid, ethylsulfuric acid, phenylphosphonic acid, phenylphosphinic acid, diphenyl phosphate, benzoic acid, isophthalic acid, adipic acid, p-toluic acid, 3,4-dimethoxybenzoic acid, phthalic acid, terephthalic acid, 4-cyclohexene-1,2-dicarboxylic acid, erucic acid, lauric acid, n-undecanoic acid, and ascorbic acid.

The ratio of the acid anhydride, phenolic compound and organic acid in all solid contents of the lower or upper layer is preferably from 0.05 to 20% by mass, more preferably from 0.1 to 15% by mass, even more preferably from 0.1 to 10% by mass.

(Surfactant)

The following may be added to the upper layer and/or the lower layer, which constitute(s) the recording layer related to the invention, in order to improve the applicability of a solution or solutions for forming the layer(s) or obtain the stability of developing treatment under wider developing conditions: a nonionic surfactant as described in JP-A Nos. 62-251740 and 3-208514; an amphoteric surfactant as described in JP-A Nos. 59-121044 and 4-13149; a siloxane compound as described in EP No. 950517; or a copolymer made from a fluorine-containing monomer, as described in JP-A Nos. 62-170950 and 11-288093, and Japanese Patent Application No. 2001-247351.

Specific examples of the nonionic surfactant include sorbitan tristearate, sorbitan monopalmitate, sorbitan trioleate, monoglyceride stearate, and polyoxyethylene nonyl phenyl ether. Specific examples of the amphoteric surfactant include alkyldi(aminoethyl)glycine, alkylpolyaminoethylglycine hydrochloride, 2-alkyl-N-carboxyethyl-N-hydroxyethylimidazolium betaine, and N-tetradecyl-N,N-betaine type surfactants (trade name: “Amorgen K”, manufactured by Daiichi Kogyo Co., Ltd., and others).

The siloxane compound is preferably a block copolymer of dimethylsiloxane and polyalkylene oxide. Specific examples thereof include polyalkylene oxide modified silicones (trade names: DBE-224, DBE-621, DBE-712, DBP-732 and DBP-534 (trade name, manufactured by Chisso Corp.), and Tego Glide 100 (trade name, manufactured by Tego Co. in Germany)).

The ratio of the nonionic surfactant and the amphoteric surfactant in all solid contents of the lower or upper layer is preferably from 0.01 to 15% by mass, more preferably from 0.1 to 5.0% by mass, even more preferably from 0.5 to 2.0% by mass.

(Printing-Out Agent/Coloring Agent)

To the upper layer and/or the lower layer, which constitute(s) the recording layer related to the invention, may be added a printing-out agent for yielding a visible image immediately after the layer(s) is/are heated by exposed to light, or a dye or pigment as an image coloring agent.

A typical example of the printing-out agent is a combination of a compound which releases an acid by being heated by exposure to light (optically acid-releasing agent) with an organic dye which can form a salt. Specific examples thereof include combinations of o-naphthoquinonediazide-4-sulfonic acid halogenide with a salt-formable organic dye, described in JP-A Nos. 50-36209 and 53-8128; and combinations of a trihalomethyl compound with a salt-formable organic dye, described in JP-A Nos. 53-36223, 54-74728, 60-3626, 61-143748, 61-151644 and 63-58440. The trihalomethyl compound is an oxazole type compound or a triazine type compound. The two-type compounds are excellent in stability over time and can give vivid printed-out images.

The image coloring agent may be the above-mentioned salt-formable organic dye or some other dye than the salt-formable organic dye, and is preferably an oil-soluble dye or a basic dye. Specific examples thereof include Oil Yellow # 101, Oil Yellow # 103, Oil Pink #312, Oil Green BG, Oil Blue BOS, Oil Blue #603, Oil Black BY, Oil Black BS, and Oil Black T-505 (trade name, manufactured by Orient Chemical Industries Ltd.), Victoria Pure Blue, Crystal Violet Lactone, Crystal Violet (CI42555), Methyl Violet (CI42535), Ethyl Violet, Rhodamine B (CI145170B), Malachite Green (CI42000), and methylene Blue (CI52015). Dyes described in JP-A No. 62-293247 are particularly preferable.

The ratio of the dye in all solid contents of the lower or upper layer is from 0.01 to 10% by mass, preferably from 0.1 to 3% by mass.

(Plasticizer)

A plasticizer may be added to the upper layer and/or the lower layer, which constitute(s) the recording layer related to the invention, in order to give flexibility and others to the layer(s). Examples of the plasticizer include butylphthalyl, polyethylene glycol, tributyl citrate, diethyl phthalate, dibutyl phthalate, dihexyl phthalate, dioctyl phthalate, tricresyl phosphate, tributyl phosphate, trioctyl phosphate, tetrahydrofurfuryl oleate, and oligomer and polymer of acrylic acid or methacrylic acid.

The ratio of the plasticizer in all solid contents of the lower or upper layer is from 0.5 to 10% by mass, preferably from 1.0 to 5% by mass.

(Wax Agent)

A compound for lowering the static frictional coefficient of the surface of the upper layer may be added to the upper layer related to the invention in order to give scratch resistance thereto. Specific examples of the compound include compounds having an ester group of a long chain alkylcarboxylic acid, as described in U.S. Pat. No. 6,117,913 and Japanese Patent Applications Nos. 2001-261627, 2002-032904 and 2002-165584, which were previously filed by the present Applicant.

The ratio of the compound in the upper layer is preferably from 0.1 to 10% by mass, more preferably from 0.5 to 5% by mass.

[Formation of the Recording Layer]

Usually, the upper and lower layers in the second planographic printing plate precursor of the invention can be formed by dissolving the above-mentioned components in a solvent, and then applying the resultant solution onto an appropriate support.

Examples of the solvent used at this time include ethylene dichloride, cyclohexanone, methyl ethyl ketone, methanol, ethanol, propanol, ethylene glycol monomethyl ether, 1-methoxy-2-propanol, 2-methoxyethyl acetate, 1-methoxy-2-propyl acetate, dimethoxyethane, methyl lactate, ethyl lactate, N,N-dimethylacetoamide, N,N-dimethylformaldehyde, tetramethylurea, N-methylpyrrolidone, dimethylsulfoxide, sulfolane, γ-butyrolactone and toluene. However, the solvent is not limited to these solvents. These solvents may be used alone or in a mixture form.

In principle, it is preferable to form the lower and upper layers separately.

Examples of the method for forming the two layers separately include a method of using difference between the solubilities of components contained in the lower layer and components contained in the upper layer in a solvent, and a method of applying a coating solution for the upper layer, and then drying/removing the solvent therein rapidly.

These methods are described in detail hereinafter. The method for forming the two layers separately is not limited to these methods.

The method of using difference between the solubilities of components contained in the lower layer and components contained in the upper layer in a solvent is a method of using a solvent in which none of the components contained in the lower layer can be dissolved when a coating solution for the upper layer is applied. According to this method, the two layers can be formed in the state that they are clearly separated even if coating solutions for the two layers are applied. For example, the formation of the two layers can be attained by selecting, as the lower layer components, components insoluble in a solvent wherein the alkali-soluble resin, which is one of the upper layer components, can be dissolved (for example, methyl ethyl ketone or 1-methoxy-2-propanol); applying a coating solution for the lower layer, in which a solvent wherein the lower layer components can be dissolved is used; drying the coating solution; dissolving the upper layer components, which are made mainly of the alkali-soluble resin, into methyl ethyl ketone, 1-methoxy-2-propanol or the like; applying the resultant solution; and then drying the solution.

Examples of the method of applying a coating solution for the second layer (the upper layer), and then drying the solvent therein very rapidly include a method of blowing high-pressure air on the web (comprising the lower and upper layers) from a slit nozzle arranged perpendicularly to the running direction of the web; a method of giving thermal energy as conductive heat from a roll (heating roll) into which a heating medium such as vapor is supplied onto the web from the lower surface thereof; and a combination of these methods.

In order to give a new function to the recording layer, the upper and lower layers may be positively subjected to partial compatibility with each other as far as the advantageous effects of the invention can be sufficiently exhibited. The method may be a method of using the above-mentioned difference between solubilities in a solvent, or a method of applying the coating solution for the second layer and then drying the solvent therein very rapidly. In either case, the new function can be obtained by adjusting the degree of the partial compatibility.

The concentration of the components except the solvent (i.e., that of all solid contents, which comprises the additives) in the coating solution for the lower or upper layer, which is applied onto a support, is preferably from 1 to 50% by mass.

Examples of the method for the application include bar coater, spin, spray, curtain, dip, air knife, blade and roll coatings.

In order to prevent the lower layer from being damaged when the upper layer coating solution is applied, the method for applying the upper layer coating solution is desirably in a non-contact manner. The method which is in a contact manner but is generally used for application of a solvent is bar coater coating. In this method, the bar coater is desirably driven in a forward direction in order to prevent damage from being given to the lower layer.

In the second planographic printing plate precursor of the invention, the amount of the lower layer components applied onto a support is preferably from 0.5 to 4.0 g/m², more preferably from 0.6 to 2.5 g/m² after the components are dried, in order to give good sensitivity and printing durability.

The amount of the applied upper layer components is preferably from 0.05 to 1.0 g/m², more preferably from 0.08 to 0.7 g/m² after the layer is dried, in order to give high sensitivity, wide development latitude, and good scratch resistance.

The total amount of the applied upper and lower layers is preferably from 0.6 to 4.0 g/m², more preferably from 0.7 to 2.5 g/m² after the layers are dried, in order to give high sensitivity, image reproducibility and printing durability.

First Planographic Printing Plate Precursor of the Invention

The planographic printing plate precursor of the invention having a mono-layered recording layer, that is, the first planographic printing plate precursor is described in detail hereinafter.

In the first planographic printing plate precursor of the invention, it is essential that its recording layer comprises the same water-insoluble and alkali-soluble resin having active hydrogen in the main chain thereof, and infrared absorbent as described above.

[Mono-Layered Recording Layer]

The mono-layered recording layer in the first planographic printing plate precursor of the invention has the same structure as the upper layer of the multi-layered recording layer except that the above-mentioned water-insoluble and alkali-soluble resin having active hydrogen in the main chain thereof is used as the main component of alkali-soluble resins of the mono-layered recording layer. In other words, the mono-layered recording layer comprises the water-insoluble and alkali-soluble resin having active hydrogen in the main chain thereof, and the infrared absorbent, and other optional additives, which are used as far as the advantageous effects of the invention are not damaged, are the same as in the upper layer. In the case that an infrared absorbent having no dissolution inhibiting effect is used as the infrared absorbent, it is preferable to use a development inhibitor as one of the optional components.

As described above, the amount of the specific alkali-soluble resin out of the alkali-soluble resins contained in the mono-layered recording layer is preferably over 50% by mass. The other alkali-soluble resin components, which can be used together, are the same as described above.

In the case of the mono-layered recording layer, the content by percentage of the whole of the alkali-soluble resins including the specific alkali-soluble in all solid contents of the recording layer is preferably from 5 to 90% by mass, more preferably from 10 to 85%, most preferably from 50 to 80% by mass.

The content by percentage of the development inhibitor in all the solid contents is preferably from about 2 to 20% by mass, more preferably from about 3 to 15% by mass.

The content by percentage of the infrared absorbent in all the solid contents is preferably from about 1 to 15%, more preferably from about 2 to 10% by mass.

The amount of the applied mono-layered recording layer is from 0.7 to 3.5 g/m², more preferably from 0.8 to 2.0 g/m² after the recording layer is dried, in order to give high sensitivity and printing durability.

[Support]

The support which is used in each of the first and second planographic printing plate precursors of the invention may be any plate-form product that has necessary strength and endurance and is dimensionally stable. Examples thereof include a paper sheet; a paper sheet on which a plastic (such as polyethylene, polypropylene, or polystyrene) is laminated; a metal plate (such as an aluminum, zinc, or copper plate), a plastic film (such as a cellulose diacetate, cellulose triacetate, cellulose propionate, cellulose lactate, cellulose acetate lactate, cellulose nitrate, polyethylene terephthalate, polyethylene, polystyrene, polypropylene, polycarbonate, or polyvinyl acetal film); and a paper or plastic film on which a metal as described above is laminated or vapor-deposited.

Of these supports, a polyester film or an aluminum plate is preferable in the invention. An aluminum plate is particularly preferable since the plate is good in dimensional stability and relatively inexpensive. Preferable examples of the aluminum plate include a pure aluminum plate, and alloy plates comprising aluminum as the main component and a small amount of different elements. A plastic film on which aluminum is laminated or vapor-deposited may be used. Examples of the different elements contained in the aluminum alloy include silicon, iron, manganese, copper, magnesium, chromium, zinc, bismuth, nickel, and titanium. The content by percentage of the different elements in the alloy is at most 10% by mass.

In the invention, pure aluminum is particularly preferable. However, completely pure aluminum is not easily produced from the viewpoint of metallurgy technology. Thus, aluminum containing a trance amount of the different elements may be used.

As described above, the aluminum plate used in the invention, the composition of which is not specified, may be any aluminum plate that has been known or used hitherto. The thickness of the aluminum plate used in the invention is generally from about 0.1 to 0.6 mm, preferably from 0.15 to 0.4 mm, and more preferably from 0.2 to 0.3 mm.

Such an aluminum plate may be subjected to surface treatment such as surface-roughening treatment or anodizing treatment if necessary. The surface treatment is briefly described hereinafter.

Before the surface of the aluminum plate is roughened, the plate is subjected to degreasing treatment with a surfactant, an organic solvent, an aqueous alkaline solution or the like if desired, in order to remove rolling oil on the surface. The roughening treatment of the aluminum plate surface is performed by any one of various methods, for example, by a mechanically surface-roughening method, or a method of dissolving and roughening the surface electrochemically, or a method of dissolving the surface selectively in a chemical manner.

The mechanically surface-roughening method which can be used may be a known method, such as a ball polishing method, a brush polishing method, a blast polishing method or a buff polishing method. The electrochemically surface-roughening method may be a method of performing surface-roughening in a hydrochloric acid or nitric acid electrolyte by use of alternating current or direct current. As disclosed in JP-A No. 54-63902, a combination of the two may be used.

The aluminum plate the surface of which is roughened as described above is subjected to alkali-etching treatment and neutralizing treatment if necessary. Thereafter, the aluminum plate is subjected to anodizing treatment if desired, in order to improve the water holding ability or wear resistance of the surface. The electrolyte used in the anodizing treatment of the aluminum plate is any one selected from various electrolytes which can make a porous oxide film. There is generally used sulfuric acid, phosphoric acid, oxalic acid, chromic acid, or a mixed acid thereof. The concentration of the electrolyte may be appropriately decided dependently on the kind of the electrolyte.

Conditions for the anodizing treatment cannot be specified without reservation since the conditions vary dependently on the used electrolyte. The following conditions are generally suitable: an electrolyte concentration of 1 to 80% by mass, a solution temperature of 5 to 70° C., a current density of 5 to 60 A/dm², a voltage of 1 to 100 V, and an electrolyzing time of 10 seconds to 5 minutes. If the amount of the anodic oxide film is less than 1.0 g/m², the printing durability is insufficient or non-image areas of the planographic printing plate are easily injured so that the so-called “injury stains”, resulting from ink adhering to injured portions at the time of printing, are easily generated.

If necessary, the aluminum surface is subjected to treatment for hydrophilicity after the anodizing treatment.

The treatment for hydrophilicity which can be used in the invention may be an alkali metal silicate (for example, aqueous sodium silicate solution) method, as disclosed in U.S. Pat. Nos. 2,714,066, 3,181,461, 3,280,734, and 3,902,734. In this method, the support is subjected to immersing treatment or electrolyzing treatment with aqueous sodium silicate solution. Besides, there may be used a method of treating the support with potassium fluorozirconate disclosed in JP-B No. 36-22063 or with polyvinyl phosphonic acid, as disclosed in U.S. Pat. Nos. 3,276,868, 4,153,461, and 4,689,272.

[Undercoat Layer]

In the first and second planographic printing plate precursors of the invention, an undercoat layer may be formed between the support and the recording layer if necessary.

As components for the undercoat layer, various organic compounds may be used. Examples thereof include carboxymethylcellulose, dextrin, gum arabic, phosphonic acids having an amino group such as 2-aminoethylphosphonic acid, organic phosphonic acids such as phenylphosphonic acid, naphthylphosphonic acid, alkylphosphonic acid, glycerophosphonic acid, methylenediphosphonic acid and ethylenediphosphonic acid, each of which may have a substituent, organic phosphoric acids such as phenylphosphoric acid, naphthylphosphoric acid, alkylphosphoric acid and glycerophosphoric acid, each of which may have a substituent, organic phosphinic acids such as phenylphosphinic acid, naphthylphosphinic acid, alkylphosphinic acid, and glycerophosphinic acid, each of which may have a substituent, amino acids such as glycine and β-alanine, and hydrochlorides of amines having a hydroxyl group, such as hydrochloride of triethanolamine. These may be used in a mixture form.

The undercoat layer preferably contains a compound having an onium group. This compound is described in detail in JP-A Nos. 2000-10292, 2000-108538 and others. Besides, use is made of a compound selected from the group of polymer compounds each having in the molecule thereof a poly(p-vinylbenzoic acid) or some other structure unit. Specific examples thereof include copolymer made from p-vinylbenzoic acid and vinylbenzyltriethylammonium salt, and copolymer made from p-vinylbenzoic acid and vinylbenzyltrimethylammonium salt.

This organic undercoat layer can be formed by the following method: a method of dissolving the above-mentioned organic compound into water, an organic solvent such as methanol, ethanol or methyl ethyl ketone, or a mixed solvent thereof to prepare a solution, applying the solution onto an aluminum plate, and drying the solution to form the undercoat layer; or a method of dissolving the above-mentioned organic compound into water, an organic solvent such as methanol, ethanol or methyl ethyl ketone, or a mixed solvent thereof to prepare a solution, dipping an aluminum plate into the solution to cause the plate to adsorb the organic compound, washing the plate with water or the like, and then drying the plate to form the undercoat layer.

In the former method, the solution of the organic compound having a concentration of 0.005 to 10% by mass can be applied by various methods. In the latter method, the concentration of the organic compound in the solution is from 0.01 to 20% by mass, preferably from 0.05 to 5% by mass, the dipping temperature is from 20 to 90° C., preferably from 25 to 50° C., and the dipping time is from 0.1 second to 20 minutes, preferably from 2 seconds to 1 minute.

The pH of the solution used in this method can be adjusted into the range of 1 to 12 with a basic material such as ammonia, triethylamine or potassium hydroxide, or an acidic material such as hydrochloric acid or phosphoric acid. A yellow dye can be added to the solution in order to improve the reproducibility of the tone of the image recording material.

The amount of the applied organic undercoat layer is suitably from 2 to 200 mg/m², preferably from 5 to 100 mg/m² from the viewpoint of the printing durability performance of the printing plate precursor.

[Back Coat Layer]

If necessary, a back coat layer is formed on the rear surface of the support of the first and second planographic printing plate precursors of the invention. This back coat layer is preferably any one of coating layers each made of an organic polymer compound, described in JP-A No. 5-45885, and a metal oxide obtained by hydrolyzing or polycondensing an organic or inorganic metal compound, described in JP-A No. 6-35174. Of these coating layers, particularly preferable is a coating layer made of a metal oxide obtained from an alkoxy compound of silicon, such as Si(OCH₃)₄, Si(OC₂H₅)₄, Si(OC₃H₇)₄ or Si(OC₄H₉)₄ since the alkoxy compound is inexpensive and easily available and the coating layer made therefrom is excellent in resistance against developer.

The planographic printing plate precursor produced as described above is imagewise exposed to light, and subsequently subjected to developing treatment.

[Exposure to Light]

The light source which emits active rays and is used for exposing the first and second planographic printing plate precursors of the invention imagewise to light is preferably a light source having an emission wavelength in the range from near infrared wavelengths to infrared wavelengths, and is particularly preferably a solid laser or a semiconductor laser.

[Developing Treatment]

The developer which can be used in developing treatment of the first and second planographic printing plate precursors of the invention is a developer having a pH of 9.0 to 14.0, preferably 12.0 to 13.5. The developer, the category of which includes not only developer but also replenisher hereinafter, may be an aqueous alkaline solution that has been known so far. Examples thereof include aqueous solutions of inorganic alkali salts such as sodium silicate, potassium silicate, sodium triphosphate, potassium triphosphate, ammonium triphosphate, sodium biphosphate, potassium biphosphate, ammonium biphosphate, sodium carbonate, potassium carbonate, ammonium carbonate, sodium hydrogencarbonate, potassium hydrogencarbonate, ammonium hydrogencarbonate, sodium borate, potassium borate, ammonium borate, sodium hydroxide, ammonium hydroxide, potassium hydroxide and lithium hydroxide; and organic alkali agents such as monomethylamine, dimethylamine, trimethylamine, monoethylamine, diethylamine, triethylamine, monoisopropylamine, diisopropylamine, ethyleneimine, ethylenediamine, and pyridine. These aqueous alkaline soltuions may be used alone or in combination of two or more thereof.

Of the above-mentioned aqueous alkaline solutions, one preferable developer, which exhibits the effects of the invention effectively, is an aqueous solution having a pH of 12 or more and comprising alkali silicate as a base or alkali silicate obtained by mixing a base with a silicon compound. The aqueous solution is the so-called “silicate developer”. Another preferable developer is the so-called “non-silicate developer”, which does not comprise any alkali silicate but comprises a nonreducing sugar (organic compound having a buffer effect) and a base.

About the former, the developing power of aqueous solution of alkali metal silicate can be adjusted by adjusting the ratio between silicon oxide SiO₂ and alkali metal oxide M₂O, which are components of the silicate, (generally, the mole ratio of [SiO₂]/[M₂O]), and the concentration of the alkali metal silicate. For example, the following is preferably used: an aqueous solution of sodium silicate wherein the mole ratio of SiO₂/Na₂O ([SiO₂[/[Na₂O]] is from 1.0 to 1.5 and the content by percentage of SiO₂ is from 1 to 4% by mass, as disclosed in JP-A No. 54-62004; or an aqueous solution of alkali metal silicate wherein the mole ratio of SiO₂/M is from 0.5 to 0.75 (that is, the mole ratio of SiO₂/M₂O is from 1.0 to 1.5), the content by percentage of SiO₂ is from 1 to 4% by mass, and the content by percentage of potassium in all alkali metals is 20% by gram atom, as disclosed in JP-B No. 57-7427.

The so-called “non-silicate developer”, which does not comprise any alkali silicate but comprises a nonreducing sugar and a base, is also preferable for being used to develop the first and second planographic printing plate precursors of the invention. When this developer is used to develop any one of the planographic printing plate precursors, ink-adsorbing power of the recording layer can be kept better without deteriorating the surface of the recording layer.

It is preferable that this developer comprises at least one compound selected from nonreducing sugars and at least one base and the pH of the solution is from 9.0 to 13.5. The nonreducing sugars are sugars having neither aldehyde group nor ketone group and exhibiting no reducing power. The sugars are classified into trehalose type oligosaccharides, in each of which reducing groups are bonded to each other; glucosides, in each of which a reducing group of a sugar is bonded to a non-sugar; and sugar alcohols each obtained by reducing a sugar by hydrogenation. In the invention, any one of these sugars is preferably used. Examples of the trehalose type oligosaccharides include saccharose and trehalose. Examples of the glucosides include alkylglucosides, phenolglucosides, and mustard seed oil glucoside. Examples of the sugar alcohols include D,L-arabite, ribitol, xylitol, D,L-sorbitos, D,L-mannitol, D,L-iditol, D,L-talitol, dulcitol, and allodulcitol. Furthermore, maltitol, obtained by hydrogenating a disaccharide, and a reductant obtained by hydrogenating an oligosaccharide (i.e., reduced starch syrup) are preferable. Of these examples, sugar alcohol and saccharose are more preferable. D-sorbitol, saccharose, and reduced starch syrup are even more preferable since they have buffer effect within an appropriate pH range and are inexpensive.

These nonreducing sugars may be used alone or in combination of two or more thereof. The percentage thereof in the developer is preferably from 0.1 to 30% by mass, more preferably from 1 to 20% by mass from the viewpoints of the buffer effect and the developing power of the solution.

The base combined with the nonreducing sugar(s) may be an alkali agent that has been known so far. Examples thereof include inorganic alkali agents such as sodium hydroxide, potassium hydroxide, lithium hydroxide, trisodium phosphate, tripotassium phosphate, triammonium phosphate, disodium phosphate, dipotassium phosphate, diammonium phosphate, sodium carbonate, potassium carbonate, ammonium carbonate, sodium hydrogencarbonate, potassium hydrogencarbonate, ammonium hydrogencarbonate, sodium borate, potassium borate and ammonium borate; and organic alkali agents such as monomethylamine, dimethylamine, trimethylamine, monoethylamine, diethylamine, triethylamine, monoisopropylamine, diisopropylamine, triisopropylamine, n-butylamine, monoethanolamine, diethanolamine, triethanolamine, monoisopropanolamine, diisopropanolamine, ethyleneimine, ethylenediamine, and pyridine.

These alkali agents may be used alone or in combination of two or more thereof. Among the above-mentioned examples, sodium hydroxide or potassium hydroxide is preferable since the pH thereof can be adjusted within a wide range by adjusting the amount of the hydroxide added to the reducing sugar. Trisodium phosphate, tripotassium phosphate, sodium carbonate and potassium carbonate are also preferable since they have buffer effect in themselves.

The alkali agent(s) is/are added to set the pH of the developer into the range of 9.0 to 13.5. The added amount thereof is decided dependently on a desired pH, and the kind of the used nonreducing sugar, and is preferably from 10.0 to 13.2.

An alkaline buffer solution comprising a weak acid other than the above-mentioned nonreducing sugars, and a strong base may be used together with the developer. This weak acid, which is used as buffer solution, is preferably a weak acid having a dissociation constant (pK) of 10.0 to 13.2.

Such a weak acid is selected from weak acids described in “IONIZATION CONSTANTS OF ORGANIC ACIDS IN AQUEOUS SOLUTION” published by Pergamon Press Co., and other documents. Examples of the weak acid include alcohols such as 2,2,3,3-terafluoropropanol-1 (pKₐ: 12.74), trifluoroethanol (pKₐ: 12.37), and trichloroethanol (pKₐ: 12.24); aldehydes such as pyridine-2-aldehyde (pKₐ: 12.68), and pyridine-4-aldehyde (pKₐ: 12.05); compounds having a phenolic hydroxyl group, such as salicylic acid (pKₐ: 13.0), 3-hydroxy-2-naphthoic acid (pKₐ: 12.84), catechol (pKₐ: 12.6), gallic acid (pKₐ: 12.4), sulfosalicyclic acid (pKₐ: 11.7), 3,4-dihydroxysulfonic acid (pKₐ: 12.2), 3,4-dihydroxybenzoic acid (pKₐ: 11.94), 1,2,4-trihydroxybenzene (pKₐ: 11.82), hydroquinone (pKₐ: 11.56), pyrogallol (pKₐ: 11.34), o-cresol (pKₐ: 10.33), resorcinol (pKₐ: 11.27), p-cresol (pKₐ: 10.27), and m-cresol (pKₐ: 10.09); oximes such as 2-butanoneoxime (pKₐ: 12.45), acetoxime (pKₐ: 12.42), 1,2-cycloheptanedionedioxime (pKₐ: 12.3), 2-hydroxybenzaldehydeoxime (pKₐ: 12.10), dimethylglyoxime (pKₐ: 11.9), ethanediamidedioxime (pKₐ: 11.37), and acetophenoneoxime (pKₐ: 11.35); nucleic acid related materials such as adenosine (pKₐ: 12.56), inosine (pKₐ: 12.5), guanine (pKₐ: 12.3), cytosine (pKₐ: 12.2), hypoxanthine (pKₐ: 12.1), and xanthine (pKₐ: 11.9); and weak acids, such as diethylaminomethylphosphonic acid (pKₐ: 12.32), 1-amino-3,3,3-trifluorobenzoic acid (pKₐ: 12.29), isopropylidenediphosphonic acid (pKₐ: 12.10), 1,1-ethylidenediphosphonic acid (pKₐ: 11.54), 1,1-ethylidenediphosphonic acid 1-hydroxy (pKₐ: 11.52), benzimidazole (pKₐ: 12.86), thiobenzamide (pKₐ: 12.8), picolinethioamide (pKₐ: 12.55), and barbituric acid (12.5).

Among these weak acids, sulfosalicylic acid and salicylic acid are preferable. Preferable examples of the base combined with these weak acids include sodium hydroxide, ammonium hydroxide, potassium hydroxide, and lithium hydroxide. These alkali agents may be used alone or in combination of two or more thereof. The above-mentioned alkali agents are used in the state that the pH thereof is adjusted within a preferable range by selecting the concentration thereof and the combination with the weak acid appropriately.

If necessary, various surfactants or organic solvents may be added to the developer in order to promote the developing power thereof, disperse development scum, and improve the ink-affinity of image areas of the planographic printing plate. The surfactants are preferably anionic, cationic, nonionic and amphoteric surfactants.

Preferable examples of the surfactants include nonionic surfactants such as polyoxyethylene alkyl ethers, polyoxyethylene alkyl phenyl ethers, polyoxyethylene polystyryl phenyl ethers, polyoxyethylene polyoxypropylene alkyl ethers, glycerin aliphatic acid partial-esters, sorbitan aliphatic acid partial-esters, pentaerythritol aliphatic acid partial-esters, propylene glycol monoalipahtic acid esters, sucrose aliphatic acid partial-esters, polyoxyethylene sorbitan aliphatic acid partial-esters, polyethylene glycol aliphatic acid esters, polyglycerin aliphatic acid partial-esters, polyoxyethylene-modified castor oils, polyoxyethylene glycerin aliphatic acid partial-esters, aliphatic acid diethanolamides, N,N-bis-2-hydroxyalkylamines, polyoxyethylenealkylamine, triethanolamine aliphatic acid esters, and trialkylamine oxide; anionic surfactants such as aliphatic acid salts, abietic acid salts, hydroxyalkanesulfonic acid salts, alkanesulfonic acid salts, dialkylsulfosuccinic acid esters, n-alkylbenzenesulfonic acid salts, branched-alkylbenzenesulfonic acid salts, alkylnaphthalenesulfonic acid salts, alkylphenoxypolyoxyethylene propylsulfonic acid salts, polyoxyethylene alkyl sulfophenyl ether salts, N-methyl-N-oleyltaurine sodium salt, N-alkylsulfosuccinic acid monoamide disodium salt, petroleum sulfonic acid salts, sulfonated beef tallow oil, sulphates of aliphatic acid alkyl ester, alkylsulphates, polyoxyethylene alkyl ether sulphates, aliphatic acid monoglyceride sulphates, polyoxyethylene alkyl phenyl ether sulphates, polyoxyethylene styryl phenyl ether sulphates, alkylphosphates, polyoxyethylene alkyl ether phosphates, polyoxyetylene alkyl phenyl ether phosphates, partially saponificated products of styrene/oleic anhydride copolymer, partially saponificated products of olefin/maleic acid copolymer, and naphthalenesulphonate formalin condensates; cationic surfactants such as alkylamine salts, quaternary ammonium salts such as tetrabutylmmonium bromide, polyoxyethylene alkylamine salts, and polyethylene polyamine derivatives; and amphoteric surfactants such as carbobetaines, aminocarboxylic acids, sulphobetaines, aminosulphates, and imidazolins. About the above-mentioned surfactants including the wording “polyoxyethylene”, the wording can be changed into polyoxyalkylene such as polyoxymethylene, polyoxypropylene or polyoxybutylene. Surfactants including the changed wording are also included as examples of the surfactants used in the invention.

More preferable examples of the surfactants are fluorine-containing surfactants which each contain in the molecule thereof a perfluoroalkyl group. Examples thereof include anionic surfactants such as perfluoroalkylcarboxylic acid salts, perfluoroalkylsulfonic acid salts, and perfluoroalkylphosphoric acid salts; amphoteric surfactants such as perfluoroalkylbetaine; cationic surfactants such as perfluoroalkyltrimethylammonium salt; and nonionic surfactants such as perfluoroalkylamine oxide, perfluoroalkylethylene oxide adducts, oligomer which contains perfluoroalkyl and hydrophilic groups, oligomer which contains perfluoroalkyl and lipophilic groups, oligomer which contains perfluoroalkyl, hydrophilic and lipophilic groups, and urethane which contains perfluoroalkyl and lipophilic groups. The surfactants may be used alone or in combination of two or more thereof. The content by percentage of the surfactant(s) in the developer is preferably from 0.001 to 10% by mass, more preferably from 0.01 to 5% by mass.

Various development stabilizers may be incorporated into the developer. Preferable examples thereof include polyethylene glycol adducts of sugar alcohol, described in JP-A No. 6-282079, tetraalkylammonium salts such as tetrabutylammonium hydroxide, phosphonium salts such as tetrabutylphosphonium bromide, and iodonium salts such as diphenyliodonium chloride. Other examples of the stabilizer include anionic surfactants or amphoteric surfactants described in JP-A No. 50-51324, water-soluble cationic polymers described in JP-A No. 55-95946, and water-soluble amphoteric polymer electrolytes described in JP-A No. 56-142528.

Additional examples thereof include organic boron compounds to which alkylene glycol is added, described in JP-A No. 59-84241; water-soluble surfactants of a polyoxyethylene/polyoxypropylene block polymer type, described in JP-A No. 60-111246; alkylenediamine compounds with which polyoxyethylene/polyoxypropylene is substituted, described in JP-A No. 60-129750; polyethylene glycol having a weight-average molecular weight of 300 or more, described in JP-A No. 61-215554; fluorine-containing surfactants having a cationic group, described in JP-A No. 63-175858; and water-soluble ethylene oxide compounds each obtained by adding 4 or more moles of ethylene oxide to 1 mole of acid or alcohol, or water-soluble polyalkylene compounds, described in JP-A No. 2-39157.

If necessary, an organic solvent is added to the developer. This organic solvent is preferably an organic solvent the solubility of which in water is about 10% by mass or less, more preferably an organic solvent the solubility of which in water is 5% by mass or less. Examples thereof include 1-phenylethanol, 2-phenylethanol, 3-phenyl-1-propanol, 4-phenyl-1-butanol, 4-phenyl-2-butanol, 2-phenyl-1-butanol, 2-phenoxyethanol, 2-benzyloxyethanol, o-methoxybenzyl alcohol, m-methoxybenzyl alcohol, p-methoxybenzyl alcohol, benzyl alcohol, cyclohexanol, 2-methylcyclohexanol, 3-methylcyclohexanol, 4-methylcyclohexanol, N-phenylethanolamine, and N-phenyldiethanolamine.

The content by percentage of the organic solvent is from 0.1 to 5% by mass of the total of the used liquids. The use amount of the organic solvent is closely related to the use amount of the surfactant. It is preferable to increase the amount of the surfactant as the amount of the organic solvent is increased for the following reason: if the amount of the surfactant is small and the amount of the organic solvent is large, the organic solvent is not completely dissolved; therefore, it cannot be expected to keep a good developing power.

An organic or inorganic reducing agent may be added to the developer. This agent is an agent for preventing stains of a planographic printing plate. Preferable examples of the organic reducing agent include phenolic compounds such as thiosalicylic acid, hydroquinone, metol, methoxyquinone, resorcin, and 2-methylresorcin; and amine compounds such as phenylenediamine and phenylhydrazine. Preferable examples of the inorganic reducing agent include sodium, potassium and ammonium salts of an inorganic acid such as sulfurous acid, sulfurous hydroacid, phosphorous acid, phosphorous hydroacid, phosphorous dihydroacid, thiosulfuric acid, or dithionic acid.

Of these reducing agents, sulfurous acid salt is particularly good in the effect of preventing stains. The content by percentage of the reducing agent(s) in the used developing agent is preferably from 0.05 to 5% by mass.

Furthermore, an organic carboxylic acid may be added to the developing agent. The organic carboxylic acid is preferably an aliphatic carboxylic acid or an aromatic carboxylic acid having 6 to 20 carbon atoms. Specific examples of the aliphatic carboxylic acid include caproic acid, enanthic acid, caprylic acid, lauric acid, myristic acid, palmitic acid, and stearic acid. Alkanoic acids having 8 to 12 carbon atoms are particularly preferable. Unsaturated aliphatic acids which each have, in a carbon chain thereof, a double bond, or aliphatic acids each having a branched carbon chain may be used. The aromatic carboxylic acid is a compound wherein a hydrogen atom in a benzene, naphthalene, anthracene ring or some other aromatic ring is substituted with a carboxyl group. Specific examples thereof include o-chlorobenzoic acid, p-chlorobenzoic acid, o-hydroxybenzoic acid, p-hydroxybenzoic acid, o-aminobenzoic acid, p-aminobenzoic acid, 2,4-dihydroxybenzoic acid, 2,5-dihydroxybenzoic acid, 2,6-dihydroxybenzoic acid, 2,3-dihydroxybenzoic acid, 3,5-dihydroxybenzoic acid, garlic acid, 1-hydroxy-2-naphthoic acid, 3-hydroxy-2-naphthoic acid, 2-hydroxy-1-naphthoic acid, 1-naphthoic acid, and 2-naphthoic acid. Hydroxynaphthoic acid is particularly effective.

It is preferable to use the above-mentioned aliphatic and aromatic carboxylic acids as sodium, potassium or ammonium salts thereof in order to make the water-solubility of the acids high. The content by percentage of the organic carboxylic acid of the developer used in the invention is not particularly limited. However, if the content is less than 0.1% by mass, the effect thereof is insufficient. If the content is more than 10% by mass, the effect cannot be made higher than a level. In addition, when a different additive is used, the dissolution thereof may be hindered. Accordingly, the content by percentage is preferably from 0.1 to 10%, more preferably from 0.5 to 4% by mass of the used developer.

If necessary, a preservative, a coloring agent, a thickener, an antifoamer, a water softener, and others may be incorporated into the developing agent. Examples of the water softener include polyphosphoric acid and sodium, potassium and ammonium salts thereof, ethylenediaminetetraacetic acid, diethylenetriaminepentaacetic acid, triethylenetetraminehexaacetic acid, hydroxyethylethylenediaminetriacetic acid, nitrilotriacetic acid, aminopolycarboxylic acids (such as 1,2-diaminocyclohexanetetraacetic acid, and 1,3-diamino-2-propanoltetraacetic acid) and sodium, potassium and ammonium salts, aminotri(methylenephosphonic acid), ethylenediaminetatra(methylenephosphonic acid), diethylenetriaminepenta(methylenephosphonic acid), triethylenetetraminehexa(methylenephosphonic acid), hydroxyethylethylenediaminetri(methylenephosphonic acid), 1-hydroxyethane-1,1-diphosphonic acid, and sodium, potassium and ammonium salts thereof.

The optimal amount of such a water softener varies in accordance with the degree of the chelation thereof, the hardness of the used hard water and the amount thereof, and the use amount of the water softener is generally is from 0.01 to 5% by mass, preferably at a ratio of 0.01 to 0.5% by mass of the used developer. If the use amount is smaller than this range, expected objects cannot be sufficiently attained. If the use amount is larger than this range, bad effects, such as discoloration, are produced on image areas. The balance component of the developer is water. It is advantageous for transportation of the developer that the solution is made into a concentrated solution, wherein the water content is made smaller than that contained in the developer when it is used, and the concentrated solution is diluted with water when it is used. In this case, the degree of the concentration is suitably such a degree that the respective components are not separated or precipitated.

The developer used in the invention may be a developer described in JP-A No. 6-282079. This is a developer comprising an alkali metal silicate wherein the mole ratio of SiO₂/M₂O (wherein M represents an alkali metal) is from 0.5 to 2.0 and a water-soluble ethylene oxide added compound obtained by adding 5 or more moles of ethylene oxide to one mole of a sugar alcohol having 4 or more hydroxyl groups. A sugar alcohol is a polyhydric alcohol wherein an aldehyde group or ketone group of a sugar is reduced so as to be changed to a primary or secondary alcohol group. Specific examples of the sugar alcohol include D,L-threito, D,L-erythritol, D, L-arabite, ribitol, xylitol, D,L-sorbitos, D,L-mannitol, D,L-iditol, D,L-talitol, dulcitol, allodulcitol, and di-, tri-, penta- and hexa-glycerin, wherein sugar alcohols are condensed. The above-mentioned water-soluble ethylene oxide added compound is obtained by adding 5 or more moles of ethylene oxide to one mole of any one of these sugar alcohols. If necessary, propylene oxide may be block-copolymerized with the ethylene oxide added compound as far as the solubility of the resultant copolymer is permissible. These ethylene oxide added compounds may be used alone or in combination of two or more thereof.

The added amount of the water-soluble ethylene oxide added compound(s) is preferably from 0.001 to 5% by mass, more preferably from 0.001 to 2% by mass of the developer (the used solution).

If necessary, the above-mentioned various surfactants or organic solvents may be added to the developer in order to promote the developing power thereof, disperse development scum, and improve the ink-affinity of image areas of the planographic printing plate.

The planographic printing plate precursor developed with the developer having the above-mentioned composition is subjected to post treatment with a rinsing solution containing a surfactant and so on, a finisher made mainly of gum arabic, a starch derivative or the like, and a protective gum liquid. For post treatment of the first and second planographic printing plate precursors of the invention, various combinations of these treatments can be used.

In recent years, automatic developing machines for PS plates have widely been used in order to rationalize and standardize plate-making working in the plate-making and printing industries. The automatic developing machine is generally composed of a developing section and a post-processing section, and comprises a device for carrying PS plates, various processing solution tanks, and spray devices. This machine is a machine for spraying respective processing solutions, which are pumped up, onto an exposed PS plate from spray nozzles while carrying the exposed PS plates horizontally, thereby performing developing and post-processing. Recently, there has also been known a method of immersing and carrying a PS plate in processing solution tanks filled with processing solutions by means of in-liquid guide rolls, or a method of supplying a small amount of washing water onto the surface of a printing plate after development, so as to wash the surface, and then re-using waste water therefrom as water for diluting an undiluted developer.

Such automatic processing can be performed while replenishers are replenished into the respective processing solutions in accordance with the amounts to be treated, working time, and other factors. The so-called use-and-dispose processing manner is also used, in which developing treatments are conducted with processing solutions which have not yet been substantially used.

In the case that unnecessary image areas (for example, a film edge mark of an original picture film) are present in a planographic printing plate obtained by exposing the first or second planographic printing plate precursor of the invention imagewise to light, developing the exposed precursor, and subjecting the developed precursor to water-washing and/or rinsing and/or gamming drawing treatment(s), the unnecessary image areas are erased. The erasing is preferably performed by applying an erasing solution to the unnecessary image areas, leaving the printing plate as it is for a given time, and washing the plate with water, as described in, for example, JP-B No. 2-13293. The erasing may be performed by a method of radiating active rays introduced through an optical fiber onto the unnecessary image areas, and then developing the plate, as described in JP-A No. 59-174842.

After the planographic printing plate obtained from the first or second planographic printing plate precursor of the invention is optionally coated with a desensitizing gum as described above, the plate can be supplied to a printing process. When it is desired to produce a planographic printing plate having a higher printing durability, burning treatment is applied to the planographic printing plate. In the case that the planographic printing plate is subjected to the burning treatment, it is preferable to treat the plate with a surface-adjusting solution as described in JP-B Nos. 61-2518 or 55-28062, JP-A No. 62-31859 or 61-159655 before the burning treatment.

The method for the treatment is, for example, a method of applying the surface-adjusting solution onto the planographic printing plate with a sponge or absorbent cotton infiltrated with this solution, a method of immersing the planographic printing plate in a vat filled with the surface-adjusting solution, or a method of applying the surface-adjusting solution to the planographic printing plate with an automatic coater. In the case that the applied amount of the solution is made uniform with a squeegee or a squeegee roller after the application thereof, a better result is given.

In general, the applied amount of the surface-adjusting solution is suitably from 0.03 to 0.8 g/m² (dry mass). The planographic printing plate onto which the surface-adjusting solution is applied is dried if necessary, and then the plate is heated to high temperature by a burning processor (for example, a burning processor (BP-1300) sold by Fuji Photo Film Co., Ltd.) or the like. The heating temperature and the heating time in this case, which depend on the kinds of the components which form the image, are preferably from 180 to 300° C. and from 1 to 20 minutes, respectively.

If necessary, the planographic printing plate subjected to the burning treatment can be subjected to treatments which have been conventionally conducted, such as water-washing treatment and gumming drawing. However, in the case of using the surface-adjusting solution which contains a water soluble polymer compound or the like, the so-called desensitizing treatment (for example, the gumming drawing) can be omitted. The planographic printing plate obtained by such treatments is set to an offset printing machine or some other printing machine, and is used for printing images on a great number of sheets.

### EXAMPLES

The present invention will be specifically described below by way of the following examples. However, the invention is not limited to these examples.

### Examples 1 to 8

[Production of a Support]

(Aluminum Plate)

An aluminum alloy comprising 0.06% by mass of Si, 0.30% by mass of Fe, 0.025% by mass of Cu, 0.001% by mass of Mn, 0.001% by mass of Mg, 0.001% by mass of Zn and 0.03% by mass of Ti, with the balance made of Al and inevitable impurities, was used to prepare a molten metal. The molten metal was filtrated, and then an ingot having a thickness of 500 mm and a width of 1200 mm was produced by DC casting.

Its surface was shaved by a thickness of 10 mm on average with a surface-shaving machine, and then the ingot was kept at 550° C. for about 5 hours. When the temperature thereof lowered to 400° C., a hot rolling machine was used to produce a rolled plate having a thickness of 2.7 mm. Furthermore, a continuous annealing machine was used to thermally treat the plate thermally at 500° C. Thereafter, the plate was finished by cold rolling so as to have a thickness of 0.24 mm. In this way, an aluminum plate in accordance with JIS 1050 was yielded.

The short diameter of the average crystal grain size of the resultant aluminum was 50 μm, and the long diameter thereof was 300 μm. This aluminum plate was made so as to have a width of 1030 mm. Thereafter, the plate was subjected to the following surface treatment.

(Surface Treatment)

As surface treatment, the following treatments (a) to (k) were continuously conducted. After each of the treatments and water washing, liquid on the plate was removed with nip rollers.

(a) Mechanical Surface-Roughening Treatment

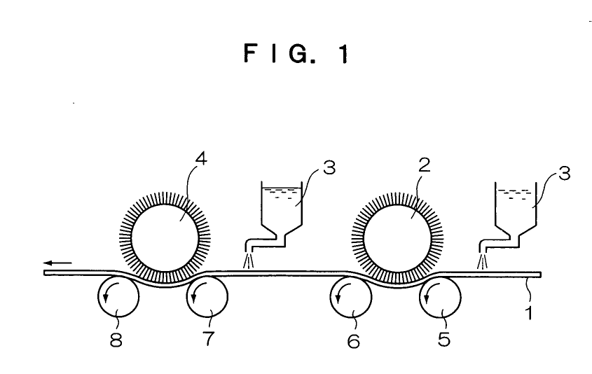

A machine as shown in FIG. 1 was used to supply a suspension (specific gravity: 1.12) of an abrasive agent (pumice) in water, as an abrading slurry, onto a surface of the aluminum plate. Simultaneously, the surface was subjected to mechanical surface-roughening treatment with rotating roller-form nylon brushes.

In FIG. 1, reference number 1 represents the aluminum plate, reference numbers 2 and 4 represent the roller-form brushes, reference number 3 represents the abrading slurry, and reference numbers 5, 6, 7 and 8 represent supporting rollers. The average grain size of the abrasive agent was 30 μm. The maximum grain size was 100 μm. The material of the nylon brushes was 6,10-nylon, the bristle length thereof was 45 mm, and the bristle diameter thereof was 0.3 mm. The nylon brushes were each obtained by making holes in a stainless steel cylinder having a diameter of 300 mm and then planting bristles densely therein. The number of the rotating brushes used was three. The distance between the two supporting rollers (diameter: 200 mm) under each of the brushes was 300 mm.

Each of the brush rollers was pushed against the aluminum plate until the load of a driving motor for rotating the brush became 7 kW larger than the load before the brush roller was pushed against the aluminum plate. The rotating direction of the brush was the same as the moving direction of the aluminum plate. The speed of rotation of the brush was 200 rpm.

(b) Alkali Etching Treatment

A 70° C. aqueous solution having a NaOH (caustic soda) concentration of 2.6% by mass and an aluminum ion concentration of 6.5% by mass was sprayed onto the aluminum plate obtained as described above to etch the aluminum plate, thereby dissolving 10 g/m² of the aluminum plate. Thereafter, the aluminum plate was washed with sprayed water.

(c) Desmut Treatment

The aluminum plate was subjected to desmut treatment with a 30° C. aqueous solution having a nitric acid concentration of 1% by mass (and containing 0.5% by mass of aluminum ions), which was sprayed, and then washed with sprayed water. The aqueous nitric acid solution used in the desmut treatment was waste liquid from a process of conducting electrochemical surface-roughening treatment using alternating current in an aqueous nitric acid solution.

(d) Electrochemical Surface-Roughening Treatment

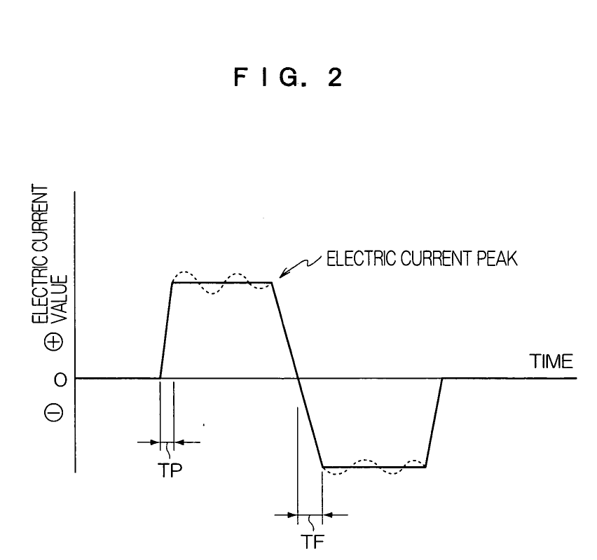

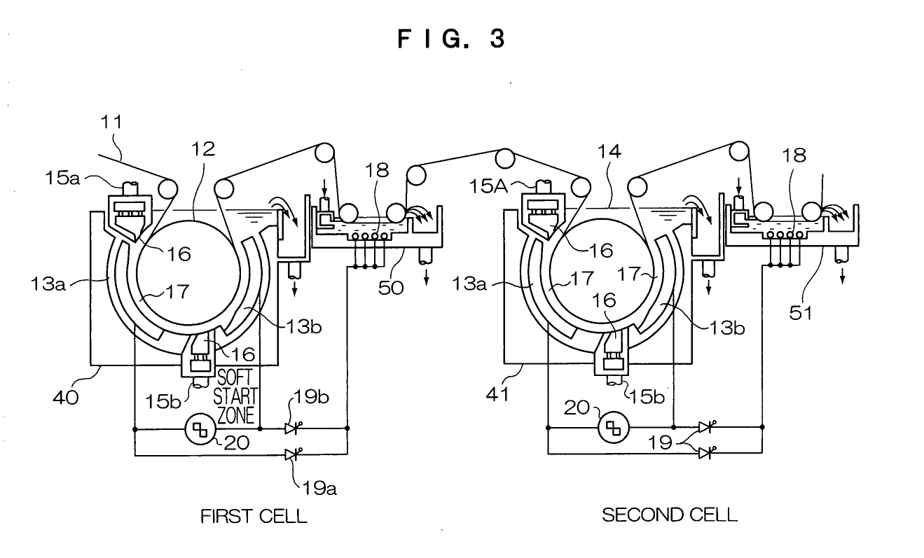

Alternating voltage having a frequency of 60 Hz was used to conduct electrochemical surface-roughening treatment continuously. The electrolyte used at this time was a 10.5 g/L solution of nitric acid in water (containing 5 g/L of aluminum ions and 0.007% by mass of ammonium ions), and the temperature thereof was 50° C. The waveform of the alternating current from a power source was a trapezoidal waveform shown in FIG. 2. The time TP until the current value was raised from zero to a peak was 0.8 msec, and the duty ratio of the current was 1:1. The trapezoidal wave alternating current was used, and a carbon electrode was set as a counter electrode to conduct the electrochemical surface-roughening treatment. Ferrite was used as an auxiliary anode. The electrolyte bath used was a bath illustrated in FIG. 3.

The density of the current was 30 A/dm² when the current was at the peak. The total electricity quantity when the aluminum plate functioned as an anode was 220 C/dm². 5% of the current sent from the power source was caused to flow into the auxiliary anode. Thereafter, the aluminum plate was washed with sprayed water.

(e) Alkali Etching Treatment

An aqueous solution having a caustic soda concentration of 2.6% by mass and an aluminum ion concentration of 6.5% by mass was used for spray to etch the aluminum plate at 32° C. so as to dissolve 0.50 g/m² of the aluminum plate, thereby removing smut components made mainly of aluminum hydroxide and generated when the alternating current was used to conduct the electrochemical surface-roughening treatment in the previous process, and further dissolving edges of formed pits so as to be made smooth. Thereafter, the aluminum plate was washed with sprayed water.

(f) Desmut Treatment

The aluminum plate was subjected to desmut treatment with a 30° C. aqueous solution having a nitric acid concentration of 15% by mass (and containing 4.5% by mass of aluminum ions), which solution was sprayed. The aluminum plate was then washed with sprayed water. The aqueous nitric acid solution used in the desmut treatment was waste liquid from the process of conducting the electrochemical surface-roughening treatment using the alternating current in the aqueous nitric acid solution.

(g) Electrochemical Surface-Roughening Treatment

Alternating voltage having a frequency of 60 Hz was used to conduct electrochemical surface-roughening treatment continuously. The electrolyte used at this time was a 5.0 g/L solution of hydrochloric acid in water (containing 5 g/L of aluminum ions), and the temperature thereof was 35° C.

The waveform of the alternating current from a power source was the trapezoidal waveform shown in FIG. 2. The time TP until the current value was raised from zero to a peak was 0.8 msec, and the duty ratio of the current was 1:1. The trapezoidal wave alternating current was used, and a carbon electrode was set as a counter electrode to conduct the electrochemical surface-roughening treatment. Ferrite was used as an auxiliary anode. The electrolyte bath used was the bath illustrated in FIG. 3.

The density of the current was 25 A/dm² when the current was at the peak. The total electricity quantity when the aluminum plate functioned as an anode was 50 C/dm². Thereafter, the aluminum plate was washed with sprayed water.

(h) Alkali Etching Treatment

An aqueous solution having a caustic soda concentration of 2.6% by mass and an aluminum ion concentration of 6.5% by mass was sprayed onto the aluminum plate to etch the plate at 32° C. so as to dissolve 0.10 g/m² of the plate, thereby removing smut components made mainly of aluminum hydroxide and generated when the alternating current was used to conduct the electrochemical surface-roughening treatment in the previous process, and further dissolving edges of formed pits so as to be made smooth. Thereafter, the aluminum plate was washed with sprayed water.

(i) Desmut Treatment

The aluminum plate was subjected to desmut treatment with a 60° C. aqueous solution having a sulfuric acid concentration of 25% by mass (and containing 0.5% by mass of aluminum ions), which solution was sprayed The aluminum plate was then washed with sprayed water.

(j) Anodizing Treatment

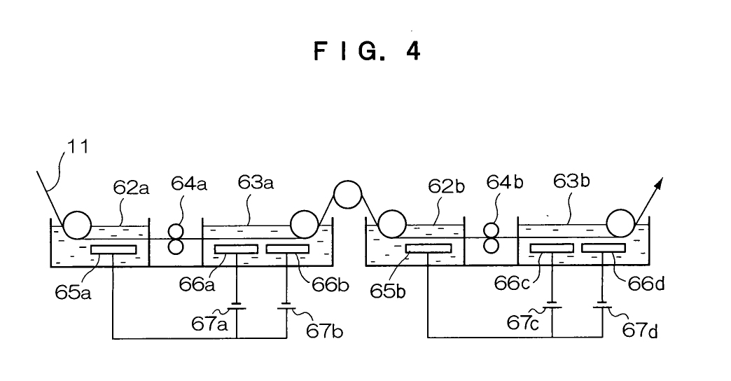

An anodizing machine having a structure illustrated in FIG. 4 (the length of each of first and second electrolyzing sections 63a and 63b being 6 m, the length of each of first and second power feeding sections 62a and 62b being 3 m, and the length of each of first and second power feeding electrodes being 2.4 m) was used to conduct anodizing treatment. Sulfuric acid was used in the electrolytes supplied to the first and second electrolyzing sections. The electrolytes each had a sulfuric acid concentration of 50 g/L (and contained 0.5% by mass of aluminum ions), and the temperature thereof was 20° C. Thereafter, the plate was washed with sprayed water.

In the anodizing machine, electric current from power sources 67a and 67b flows to a first power feeding electrode 65a provided in the first power feeding section 62a, and flows via the electrolyte to an aluminum plate 11, so as to generate an anodic oxide film on the surface of the aluminum plate 11 in the first electrolyzing section 63a. The electric current returns, through electrolyzing electrodes 66a and 66b provided in the first electrolyzing section 63a, to the electrodes 67a and 67b.

The electricity quantity supplied from the power sources 67a and 67b to the first power feeding section 62a was equal to that supplied from power sources 67c and 67d to the second power feeding section 62b, and the current densities in the first and second electrolyzing sections 63a and 63b were each about 30 A/dm². In the second power feeding section 62b, the electric current was fed through the oxide film generated in the first electrolyzing section 63a and having a density of 1.35 g/m². The density of ultimately formed oxide film was 2.7 g/m².

(k) Treatment with Alkali Metal Silicate

The aluminum support obtained by the anodizing treatment was immersed into a treatment tank containing a 30° C. aqueous solution of #3 sodium silicate (concentration of sodium silicate: 1% by mass) for 10 seconds, so as to subject the support to treatment with the alkali metal silicate (silicate treatment). Thereafter, the support was washed with sprayed water. In this way, a support whose surface had been made hydrophilic with silicate was obtained. Onto this aluminum support was applied an undercoat solution having the following composition, and then the resultant was dried at 80° C. for 15 seconds to form a coating. The amount of the dried coating was 15 mg/m².

<Undercoat solution composition>
Compound shown below: 0.3 g
Methanol: 100 g
Water: 1 g

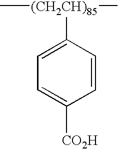

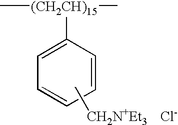

Molecular weight: 28000

[Formation of a Multi-Layered Recording Layer]

A coating solution 1 for lower layer having the following composition was applied with a bar coater onto the resultant support having the undercoat so that the applied amount thereat was 0.85 g/m². Thereafter, the resultant was dried at 160° C. for 44 seconds, and immediately cooled with cool wind having a temperature of 17 to 20° C. until the temperature of the support lowered to 35° C.

Thereafter, a coating solution 1 for upper layer having the following composition was applied onto the support with a bar coater so that the applied amount thereat was 0.22 g/m². Thereafter, the resultant was dried at 148° C. for 25 seconds and slowly cooled with wind having a temperature of 20 to 26° C. to yield a planographic printing plate precursor of Example 1. Planographic printing plate precursors of Examples 2 to 8 were obtained in a similar manner.

| | |
|---|---|
| <Coating solution 1 for lower layer> | |
| Water-insoluble and alkali-soluble resin | 2.133 g |
| having active hydrogen in the main chain thereof | |
| (shown in Table 1 below): | |
| Cyanine dye A (having a structure illustrated below): | 0.134 g |
| 4,4′-Bishydroxyphenylsulfone: | 0.126 g |
| Tetrahydrophthalic anhydride: | 0.190 g |
| p-Tolunesulfonic acid: | 0.008 g |
| 3-Methoxy-4-diazodiphenylamine hexafluorophosphate: | 0.032 g |
| Product obtained by replacing | 0.0781 g |
| the counter ion of Ethyl Violet with | |
| 6-hydroxynaphthalenesulfonic acid: | |
| Polymer 1 (having a structure illustrated below): | 0.035 g |
| Methyl ethyl ketone: | 25.41 g |
| 1-Methoxy-2-propanol: | 12.97 g |
| γ-Butyrolacetone: | 13.18 g |

Cyanine dye A

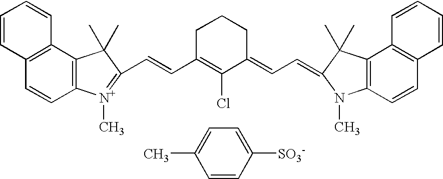

Polymer 1

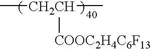

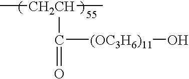

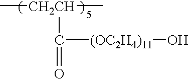

| | |
|---|---|
| <Coating solution 1 for upper layer> | |
| m,p-Cresol Novolak resin | 0.3479 g |
| (containing 0.8% by mass of unreacted cresol, | |
| the ratio of m/p = 6/4, | |
| weight-average molecular weight: 4500): | |
| Polymer 3 | 0.1403 g |
| (having a structure illustrated below, | |
| 30% solution thereof in MEK): | |
| Cyanine dye A (having the structure illustrated above): | 0.0192 g |
| Polymer 1 (having the structure illustrated above): | 0.015 g |
| Polymer 2 (having a structure illustrated below): | 0.00328 g |
| Quaternary ammonium salt | 0.0043 g |
| (having a structure illustrated below): | |
| Surfactant | 0.008 g |
| (polyoxyethylene sorbitol aliphatic acid ester, | |
| GO-4 manufactured by Nikko Chemicals Co., Ltd., HLB = | |
| 8.5): | |
| Methyl ethyl ketone: | 6.79 g |
| 1-Methoxy-2-propanol: | 13.07 g |

Polymer 2

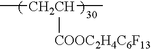

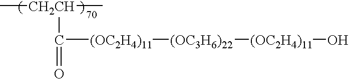

Polymer 3

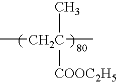

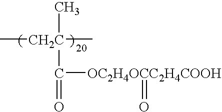

Weight-average molecular weight: 70,000
Quaternary ammonium salt

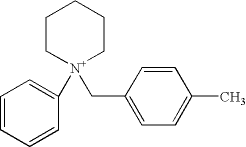

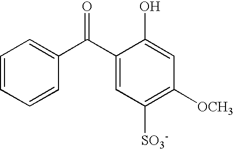

### Comparative Example 1

A planographic printing plate precursor of Comparative Example 1 was produced in the same way as in Examples 1 to 8 except that the coating solution 1 for lower layer was changed to a coating solution 2 for lower layer containing no alkali-soluble resin having active hydrogen in the main chain thereof, and having the following composition.

<Coating solution 2 for lower layer>

| | |
|---|---|
| Acrylonitrile/methyl methacrylate/p- | 2.133 g |
| aminosulfonylphenylmethacrylamide copolymer | |
| (30/35/35, weight-average molecular weight = 50,000, | |
| acid value: 2.65 meq/g): | |
| Cyanine dye A (having the structure illustrated above): | 0.134 g |
| 4,4′-Bishydroxyphenylsulfone: | 0.126 g |
| Tetrahydrophthalic anhydride: | 0.190 g |
| p-Toluenesulfonic acid: | 0.008 g |
| 3-Methoxy-4-diazodiphenylamine hexafluorophosphate: | 0.032 g |
| Product obtained by replacing the counter ion of | 0.0781 g |
| Ethyl Violet with 6-hydroxynaphthalenesulfonic acid: | |
| Polymer 1 (having the structure illustrated above): | 0.035 g |
| Methyl ethyl ketone: | 25.41 g |
| 1-Methoxy-2-propanol: | 12.97 g |
| γ-Butyrolactone: | 13.18 g |

### Comparative Example 2

A planographic printing plate precursor of Comparative Example 2 was produced in the same way as in Examples 1 to 8 except that the coating solution 1 for lower layer was changed to a coating solution 3 for lower layer containing no alkali-soluble resin having active hydrogen in the main chain thereof, and having the following composition.

<Coating solution 3 for lower layer>

| | |
|---|---|
| m,p-Cresol Novolak resin | 2.133 g |
| (containing 0.5% by mass of unreacted cresol, | |
| the ratio of m/p = 6/4, | |
| weight-average molecular weight: 7,000): | |
| Cyanine dye A (having the structure illustrated above): | 0.134 g |
| 4,4′-Bishydroxyphenylsulfone: | 0.126 g |
| Tetrahydrophthalic anhydride: | 0.190 g |
| p-Toluenesulfonic acid: | 0.008 g |
| 3-Methoxy-4-diazodiphenylamine hexafluorophosphate: | 0.032 g |
| Product obtained by replacing the counter ion of | 0.0781 g |
| Ethyl Violet with 6-hydroxynaphthalenesulfonic acid: | |
| Polymer 1 (having the structure illustrated above): | 0.035 g |
| Methyl ethyl ketone: | 25.41 g |
| 1-Methoxy-2-propanol: | 12.97 g |
| γ-Butyrolactone: | 13.18 g |

[Evaluation of the Planographic Printing Plate Precursors]
(Evaluation of Printing Durability)

A Trendsetter manufactured by Creo Co. was used to draw test patterns imagewise on the planographic printing plate precursors of Examples 1 to 8 and Comparative Examples 1 and 2 while energy for exposure to light was changed. Thereafter, a PS processor LP940H manufactured by Fuji Photo Film Co., Ltd., in which a developer DT-2 (diluted so as to have an electric conductivity of 43 mS/cm) manufactured by Fuji Photo Film Co., Ltd. was charged, was used to develop the precursors at a developing temperature of 30° C. with a developing time of 12 seconds. The resultant printing plates were used to print images continuously on sheets by means of a printer Lithron, manufactured by Komori Corp.

It was visually observed how many sheets on which the images were printed so as to have a sufficient ink density were obtained, so as to evaluate the printing durability of the printing plates. The greater the number of sheet was, the better the printing durability was evaluated to be. The results are shown in Table 1 below.

(Evaluation of Chemical Resistance Evaluation)

Using the planographic printing plate precursors of Examples 1 to 8 and Comparative Examples 1 and 2, exposure, development and printing were performed in a similar manner as in the above-described evaluation of printing durability. To this process was added the process of wiping the surface of each of the printing plates with a cleaner (multicleaner, manufactured by Fuji Photo Film Co., Ltd.) after each time images were printed on 5000 sheets. In this way, the chemical resistance was evaluated. The greater the number of sheet was, the better the printing durability was evaluated to be. The results are shown in Table 1.

TABLE 1

| | Water-insoluble | | Chemical |
|---|---|---|---|
| | and alkali-soluble | Printing durability/ | resistance/number |
| | resin having | number of sheets | of sheets printed |
| | active hydrogen | printed with images | with images |
| | in the main | having sufficient ink | having sufficient |
| | chain thereof | density | ink density |
| Example 1 | (P-1) | 250000 | 200000 |
| Example 2 | (P-2) | 300000 | 280000 |
| Example 3 | (P-3) | 300000 | 280000 |
| Example 4 | (P-4) | 270000 | 250000 |
| Example 5 | (P-13) | 280000 | 240000 |
| Example 6 | (P-14) | 300000 | 260000 |
| Example 7 | (P-15) | 250000 | 230000 |
| Example 8 | (P-12) | 290000 | 280000 |
| Comparative | — | 170000 | 150000 |
| Example 1 | | | |
| Comparative | — | 10000 | 5000 |
| Example 2 | | | |

As is clear from Table 1, the planographic printing plate precursors of Examples 1 to 8 according to the invention, in which the water-insoluble and alkali-soluble resin having active hydrogen in the main chain thereof was used as one of the components of the lower layer, had satisfactory printing durability and chemical resistance.

The planographic printing plate precursor of Comparative Example 1, in which the alkali-soluble resin containing a p-aminosulfonylphenylmethacrylamide skeleton was used as one of the components of the lower layer, had poorer printing durability and chemical resistance than those of Examples 1 to 8. The planographic printing plate precursor of Comparative Example 2, in which only the Novolak resin was used instead of the water-insoluble and alkali-soluble resin having active hydrogen in the main chain thereof, had far poorer printing durability and chemical resistance than those of Examples 1 to 8 and Comparative Example 1.

### Example 9 to 16

[Formation of Supports]

An aluminum plate (JIS A 1050 material) of 0.3 mm thickness was etched with an etching solution having a caustic soda concentration of 30 g/L and an aluminum ion concentration of 10 g/L (solution temperature: 60° C.) for 10 seconds, washed with flowing water, neutralized with a nitric acid solution having a nitric acid concentration of 10 g/L, and washed with water. An alternating current having a sine waveform was used to subject the aluminum plate to electrochemical surface-roughening treatment in an aqueous solution having a hydrogen chloride concentration of 15 g/L and an aluminum ion concentration of 10 g/L (solution temperature: 30° C.) at an applied voltage Va of 20 V and an electricity quantity of 500 C/dm². The aluminum plate was washed with water, etched with an etching solution having a caustic soda concentration of 30 g/L and an aluminum ion concentration of 10 g/L (solution temperature: 40° C.) for 10 seconds, and washed with flowing water.

Next, the aluminum plate was subjected to desmut treatment in an aqueous sulfuric acid solution having a sulfuric acid concentration of 15% by mass (solution temperature: 30° C.) and then washed with water. The aluminum plate was further subjected to anodizing treatment in an aqueous sulfuric acid solution having a sulfuric acid concentration of 10% by mass (solution temperature: 20° C.) at a direct current density of 6 A/dm² such that the amount of the resultant anodic oxide film was 2.5 g/m². The aluminum plate was washed with water, dried, and then treated with an aqueous solution having a sodium silicate concentration of 2.5% by mass at 30° C. for 10 seconds to form a substrate.

A needle having a diameter of 2 μm was used to measure the central line average roughness (Ra) of this substrate. As a result, the central line average roughness was found to be 48 μm. An undercoat solution having the following composition was applied onto the silicate-treated aluminum substrate, which was obtained as described above, and then dried at 80° C. for 15 seconds to form an undercoat. The amount of the dried undercoat was 17 mg/m².

<Undercoat solution composition>
Compound illustrated below: 0.3 g
Methanol: 100 g
Water: 1 g

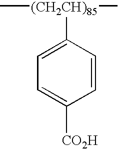

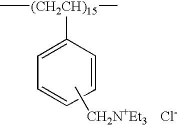

Molecular weight: 28000

[Formation of a Mono-Layered Recording Layer]

A coating solution A for recording layer having the following composition was applied onto the undercoated support, obtained as describe above, so that the amount of the applied solution A was 1.8 g/m², and then dried to form a recording layer, thereby yielding a planographic printing plate precursor of Example 9. Planographic printing plate precursors of Examples 10 to 16 were obtained in a manner similar to that described above.

<Coating solution A for recording layer>

| | |
|---|---|
| m,p-Cresol Novolak resin | 0.5 g |
| (containing 0.5% by mass of unreacted cresol, | |
| the ratio of m/p = 6/4, weight-average molecular weight: 7,000): | |
| Water-insoluble and alkali-soluble resin | 1.0 g |
| having active hydrogen in the main chain thereof | |
| (shown in Table 2 below): | |
| Cyanine dye A (having the structure illustrated above): | 0.1 g |
| Phthalic anhydride: | 0.05 g |
| p-Toluenesulfonic acid: | 0.002 g |
| Product obtained by replacing the counter ion of | 0.02 g |
| Ethyl Violet with 6-hydroxy-β-naphthalenesulfonic acid: | |
| Fluorine-containing polymer | 0.015 g |
| (MEGAFACE F-176 (solid content: 20%), | |
| manufactured by Dainippon Ink & Chemicals, Inc.): | |
| Fluorine-containing polymer | 0.035 g |
| (MEGAFACE MCF-312 (solid content: 30%), | |
| manufactured by Dainippon Ink & Chemicals, Inc.): | |
| Lauryl stearate: | 0.03 g |
| γ-Butyrolactone: | 8.5 g |
| 1-Methoxy-2-propanol: | 3.5 g |

### Comparative Example 3

[Formation of a Recording Layer]

A coating solution B for recording layer having the following composition was applied onto the same undercoated support as in Examples 9 to 16 such that the amount of the applied solution B was 1.8 g/m², and then dried to form a recording layer, thereby yielding a planographic printing plate precursor of Comparative Example 3.

<Coating solution B for recording layer>

| | | |
|---|---|---|
| m,p-Cresol Novolak resin | 0.5 | g |
| (containing 0.5% by mass of unreacted cresol, | | |
| ratio of m/p = 6/4, | | |
| weight-average molecular weight: 7,000): | | |
| Acrylonitrile/methyl acrylate/ | 1.0 | g |
| p-aminosulfonylphenylmethacrylamide copolymer | | |
| (30/35/35, weight-average molecular weight = 50,000, | | |
| acid value = 2.65 meq/g): | | |
| Cyanine dye A (having the structure illustrated above): | 0.1 | g |
| Phthalic anhydride: | 0.05 | g |
| p-Toluenesulfonic acid: | 0.002 | g |
| Product obtained by replacing the counter ion of | 0.02 | g |
| Ethyl Violet with 6-hydroxy-β-naphthalenesulfonic acid: | | |
| Fluorine-containing polymer | 0.015 | g |
| (MEGAFACE F-176 (solid content: 20%), | | |
| manufactured by Dainippon Ink & Chemicals Inc.): | | |
| Fluorine-containing polymer | 0.035 | g |
| (MEGAFACE MCF-312 (solid content: 30%), | | |
| manufactured by Dainippon Ink & Chemicals, Inc.): | | |
| Lauryl stearate: | 0.03 | g |
| γ-Butyrolactone: | 8.5 | g |
| 1-Methoxy-2-propanol: | 3.5 | g |

### Comparative Example 4

A coating solution C for recording layer having the following composition was applied onto the same undercoated support as in Examples 9 to 16 such that the amount of the applied solution B was 1.8 g/m², and then dried to form a recording layer, thereby yielding a planographic printing plate precursor of Comparative Example 4.

<Coating solution C for recording layer>

| | |
|---|---|
| m,p-Cresol Novolak resin | 1.5 g |
| (containing 0.5% by mass of unreacted cresol, | |
| ratio of m/p = 6/4, weight-average molecular weight: 7,000) | |
| Cyanine dye A (having the structure illustrated above): | 0.1 g |
| Phthalic anhydride: | 0.05 g |
| p-Toluenesulfonic acid: | 0.002 g |
| Productobtained by replacing the counter ion of | 0.02 g |
| Ethyl Violet with 6-hydroxy-β-naphthalenesulfonic acid: | |
| Fluorine-containing polymer | 0.015 g |
| (MEGAFACE F-176 (solid content: 20%), | |
| manufactured by Dainippon Ink & Chemicals, Inc.): | |
| Fluorine-containing polymer | 0.035 g |
| (MEGAFACE MCF-312 (solid content: 30%), | |
| manufactured by Dainippon Ink & Chemicals, Inc.): | |
| Lauryl stearate: | 0.03 g |
| γ-Butyrolactone: | 8.5 g |
| 1-Methoxy-2-propanol: | 3.5 g |

[Evaluation of the Printing Durability and the Chemical Resistance of the Planographic Printing Plate Precursors]

Using the planographic printing plate precursors of Examples 9 to 16 and Comparative Examples 3 and 4, exposure to light, development and printing were performed in the same way as in Examples 1 to 8. Furthermore, the printing durability and the chemical resistance thereof were evaluated in the same way. The results are shown in Table 2.

TABLE 2

| | Water- | | |
|---|---|---|---|
| | insoluble and | | |
| | alkali-soluble | | |
| | resin | Printing durability/ | Chemical resistance/ |
| | having active | number of sheets | number of sheets |
| | hydrogen | printed with images | printed with images |
| | in the main | having sufficient ink | having sufficient ink |
| | chain thereof | density | density |
| Example 9 | (P-2) | 270000 | 250000 |
| Example 10 | (P-13) | 280000 | 270000 |
| Example 11 | (P-6) | 290000 | 280000 |
| Example 12 | (P-7) | 240000 | 220000 |
| Example 13 | (P-9) | 250000 | 230000 |
| Example 14 | (P-14) | 260000 | 230000 |
| Example 15 | (P-11) | 240000 | 230000 |
| Example 16 | (P-15) | 270000 | 260000 |
| Comparative | — | 150000 | 120000 |
| Example 3 | | | |
| Comparative | — | 10000 | 5000 |
| Example 4 | | | |

As is clear from Table 2, the planographic printing plate precursors of Examples 9 to 16 were excellent in printing durability and chemical resistance.

The planographic printing plate precursor of Comparative Example 3, in which the alkali-soluble resin containing a p-aminosulfonylphenylmethacrylamide skeleton was used as one of the components of the recording layer, had poorer printing durability and chemical resistance than those of Examples 9 to 16. The planographic printing plate precursor of Comparative Example 4, in which only the Novolak resin was used instead of the water-insoluble and alkali-soluble resin having active hydrogen in the main chain thereof, had far poorer printing durability and chemical resistance than those of Examples 9 to 16 and Comparative Example 3.

It can be understood from the foregoing that the water-insoluble and alkali-soluble resin having active hydrogen in the main chain thereof, related to the invention, exhibits excellent printing durability and chemical resistance when the resin is used as a component of a mono-layered recording layer as well as when the resin is used as a component of a lower layer of a multi-layered recording layer.

Further, comparison of Examples 1 to 8 with Examples 9 to 16 demonstrates that the advantageous effects of the invention are more remarkable in the planographic printing plate precursor having a multi-layered recording layer (the second planographic printing plate precursor of the invention).

### Example 17

An undercoat and a recording layer (upper and lower layers) were formed in the same way as in Examples 1 to 8 except that no silicate treatment was conducted after the anodizing treatment 0) in the production of the support, so as to produce a planographic printing plate precursor of Example 17.

(Evaluation of Printing Durability and Chemical Resistance)

The resultant planographic printing plate precursor of Example 17 was exposed to light in the same way as in Examples 1 to 8, and then a PS processor LP940H manufactured by Fuji Photo Film Co., Ltd., in which the following alkaline developer A was charged, was used to develop the photographic printing plate precursor with a developing time of 25 seconds while the developing temperature was kept at 28° C.

<Composition of an alkaline developer A>

| | |
|---|---|
| SiO₂—K₂O (mole ratio of K₂O/SiO₂ = 1/1): | 4.0% by mass |
| Citric acid: | 0.5% by mass |
| Polyethylene glycol modified sorbitol | 1.0% by mass |
| (a product wherein 30 units were added on average): | |
| Water: | 50% by mass |

Thereafter, the printing durability and the chemical resistance of the printing plate were evaluated in the same way as in Examples 1 to 8. As a result, for the printing durability and the chemical resistance, the numbers of sheets were 300000 and 280000, respectively. The number of sheets on which images having sufficient ink density were printed was equivalent to those of Examples 1 to 8. It was confirmed from the foregoing fact that Example 17, in which the planographic printing plate precursor using the substrate subjected to no treatment for hydrophilicity with silicate was developed with the silicate developer, achieved excellent printing durability and chemical resistance in the same manner as Examples 1 to 8, in which the planographic printing plate precursors using the silicate-treated substrate were developed with the non-silicate developer.

1. A planographic printing plate precursor, comprising:
a support; and
a recording layer which is formed on the support and comprises a water-insoluble and alkali-soluble resin having active hydrogen in a main chain thereof, and an infrared absorbent, the solubility of the recording layer in an aqueous alkaline solution being increased by exposure to light.

2. A planographic printing plate precursor according to claim 1, wherein the recording layer further comprises a development inhibitor for inhibiting the alkali-solubility of the resin.

3. A planographic printing plate precursor according to claim 2, wherein the alkali-solubility suppressing effect of the development inhibitor on the resin is canceled by exposure to light, thereby increasing the solubility of the resin in an aqueous alkaline solution.

4. A planographic printing plate precursor according to claim 1, wherein the infrared absorbent is a development inhibitor for inhibiting the alkali-solubility of the resin.

5. A planographic printing plate precursor according to claim 4, wherein the alkali-solubility suppressing effect of the infrared absorbent on the resin is canceled by exposure to light, thereby increasing the solubility of the resin in an aqueous alkaline solution.

6. A planographic printing plate precursor according to claim 1, wherein the active hydrogen of the resin has a dissociation constant pKₐ of 15 or less.

7. A planographic printing plate precursor according to claim 6, wherein the active hydrogen of the resin has a dissociation constant pKₐ of 12 or less.

8. A planographic printing plate precursor according to claim 1, wherein the active hydrogen of the resin is present on a nitrogen or carbon atom which constitutes the main chain.

9. A planographic printing plate precursor according to claim 8, wherein the active hydrogen of the resin is present on a nitrogen atom which constitutes the main chain.

10. A planographic printing plate precursor according to claim 1, wherein the resin has one or more electron withdrawing structures on one side or both sides of an atom on which the active hydrogen is present.

11. A planographic printing plate precursor according to claim 10, wherein the one or more electron withdrawing structures are one or more bivalent or higher-valent organic groups.

12. A planographic printing plate precursor according to claim 11, wherein the one or more electron withdrawing structures are one or more bivalent organic groups.

13. A planographic printing plate precursor according to claim 12, wherein the one or more bivalent electron withdrawing groups are selected from the group consisting of —CO— and —SO₂—.

14. A planographic printing plate precursor, comprising:
a support; and
a recording layer formed on the support,
wherein the recording layer comprises a water-insoluble and alkali-soluble resin having active hydrogen in a main chain thereof, and a development inhibitor for suppressing the alkali-solubility of the resin, and the alkali-solubility suppressing effect of the development inhibitor on the resin is canceled by exposure to light, thereby increasing the solubility of the resin in an aqueous alkaline solution.

15. A planographic printing plate precursor according to claim 14, wherein the active hydrogen of the resin has a dissociation constant pKₐ of 15 or less.

16. A planographic printing plate precursor according to claim 14, wherein the development inhibitor is an infrared absorbent.

17. A planographic printing plate precursor, comprising:
a support, and
a recording layer formed on the support,
wherein the recording layer comprises:
a lower layer which is formed on the support and comprises a water-insoluble and alkali-soluble resin having active hydrogen in a main chain thereof, and
an upper layer which is formed on the lower layer and comprises a water-insoluble and alkali-soluble resin and a development inhibitor, the solubility of the upper layer in an aqueous alkaline solution being increased by exposure to light,
and wherein at least one of the lower layer and the upper layer of the recording layer comprises an infrared absorbent.

18. A planographic printing plate precursor according to claim 17, wherein the development inhibitor and the infrared absorbent are the same substance.

19. A planographic printing plate precursor according to claim 17, wherein the development inhibitor inhibits the alkali-solubility of the resin of the upper layer, and the alkali-solubility suppressing effect of the development inhibitor on the resin of the upper layer is canceled by exposure to light, thereby increasing the solubility of the resin of the upper layer in an aqueous alkaline solution.

20. A planographic printing plate precursor according to claim 17, wherein the active hydrogen of the resin of the lower layer has a dissociation constant pKₐ of 15 or less.

21. A planographic printing plate precursor, comprising:
a support; and
a recording layer formed on the support,
wherein:
the recording layer comprises a lower layer and an upper layer provided on the support in this order,
the lower layer comprises a water-insoluble and alkali-insoluble resin having active hydrogen in a main chain thereof, the dissociation constant pKₐ of the active hydrogen being 15 or less,
the upper layer comprises a water-insoluble and alkali-soluble resin and a development inhibitor for suppressing the alkali-solubility of the resin of the upper layer, and
the alkali-solubility suppressing effect of the development inhibitor on the resin of the upper layer is canceled by exposure to light, thereby increasing the solubility of the resin of the upper layer in an aqueous alkaline solution.

22. A planographic printing plate precursor according to claim 21, wherein at least one of the lower layer and the upper layer of the recording layer comprises an infrared absorbent.

23. A planographic printing plate precursor according to claim 22, wherein the development inhibitor and the infrared absorbent are the same substance.
